(19) United States
(12) Patent Application Publication
(10) Pub. No.: US 2024/0403715 A1
(43) Pub. Date: Dec. 5, 2024

(54) System, Method, and Computer Program Product for Identifying Weak Points in a Predictive Model

(71) Applicant: Visa International Service Association, San Francisco, CA (US)

(72) Inventors: Liang Wang, San Jose, CA (US); Junpeng Wang, Santa Clara, CA (US); Yan Zheng, Los Gatos, CA (US); Shubham Jain, Mountain View, CA (US); Michael Yeh, Newark, CA (US); Zhongfang Zhuang, San Jose, CA (US); Wei Zhang, Fremont, CA (US); Hao Yang, San Jose, CA (US)

(21) Appl. No.: 18/694,152

(22) PCT Filed: Sep. 22, 2021
(86) PCT No.: PCT/US21/51458

§ 371 Date: Mar. 21, 2024

(51) Int. Cl. G06N 20/00; G06N 5/022

(52) U.S. Cl. CPC G06N 20/00; G06N 5/022

(57) ABSTRACT

Systems, methods, and computer program products that obtain a plurality of features associated with a plurality of samples and a plurality of labels for the plurality of samples; generate a plurality of first predictions for the plurality of samples with a first machine learning model; generate a plurality of second predictions for the plurality of samples with a second machine learning model; generate, based on the plurality of first predictions, the plurality of second predictions, the plurality of labels, and a plurality of groups of samples of the plurality of samples; determine, based on the plurality of groups of samples, a first success rate associated with the first machine learning model and a second success rate associated with the second machine learning model; and identify, based on the first success rate and the second success rate, a weak point in the machine learning first model or the second model.

### CROSS REFERENCE TO RELATED APPLICATION

This application is the United States national phase of International Application No. PCT/US2021/051458 filed Sep. 22, 2021, the entire disclosure of which is hereby incorporated by reference in its entirety.

### BACKGROUND

### 1. Technical Field

This disclosure relates to predictive models and, in some non-limiting embodiments or aspects, to identifying weak points in a predictive model.

### 2. Technical Considerations

Machine learning applications often need to compare the performance between a pair of (often “competing”) models. For example, a model deployed in production may need to be retrained periodically with fresh data. However, before the retrained model replaces the production model, testing should ensure that the retrained model performs better than the production model.

### SUMMARY

Accordingly, provided are improved systems, devices, products, apparatus, and/or methods for identifying weak points in a predictive model.

According to some non-limiting embodiments or aspects, provided is a computer-implemented method, including: obtaining, with at least one processor, a plurality of features associated with a plurality of samples and a plurality of labels for the plurality of samples; generating, with the at least one processor, a plurality of first predictions for the plurality of samples by providing, as input to a first machine learning model, a first subset of features of the plurality of features, and receiving, as output from the first machine learning model, the plurality of first predictions for the plurality of samples; generating, with the at least one processor, a plurality of second predictions for the plurality of samples by providing, as input to a second machine learning model, a second subset of features of the plurality of features, and receiving, as output from the second machine learning model, the plurality of second predictions for the plurality of samples; generating, with the at least one processor, based on the plurality of first predictions, the plurality of second predictions, the plurality of labels, and a plurality of groups of samples of the plurality of samples; determining, with the at least one processor, based on the plurality of groups of samples, a first success rate associated with the first machine learning model and a second success rate associated with the second machine learning model; and identifying, with the at least one processor, based on the first success rate and the second success rate, a weak point in the second machine learning model associated with a first portion of samples of the plurality of samples including a same first value for a same first feature of the plurality of features and for which the first success rate associated with the first machine learning model is different than the second success rate associated with the second machine learning model.

In some non-limiting embodiments or aspects, at least one of: (i) the first subset of features is different than the second subset of features; (ii) a first set of hyperparameters for a machine learning algorithm used to generate the first machine learning model is different than a second set of hyperparameters for a same machine learning algorithm used to generate the second machine learning model; (iii) a first machine learning algorithm used to generate the first machine learning model is different than a second machine learning algorithm used to generate the second machine learning model; and (iv) a first training data set used to train the first machine learning model is different than a second training data set used to train the second machine learning model.

In some non-limiting embodiments or aspects, the first subset of features is different than the second subset of features, and identifying the weak point in the second machine learning model further includes: determining a difference in features between the first subset of features and the second subset of features; selecting, based on the same first feature included in the first portion of samples and the difference in features, one or more features of the plurality of features; adjusting the second subset of features based on the selected one or more features; and generating, using the adjusted second subset of features, an updated second machine learning model.

In some non-limiting embodiments or aspects, a first set of hyperparameters for a machine learning algorithm used to generate the first machine learning model is different than a second set of hyperparameters for a same machine learning algorithm used to generate the second machine learning model, and wherein identifying the weak point in the second machine learning model further includes: determining a difference in hyperparameters between the first set of hyperparameters and the second set of hyperparameters; determining, based on the same first feature included in the first portion of samples and the difference in the hyperparameters, one or more hyperparameters; adjusting the second set of hyperparameters based on the selected one or more hyperparameters; and generating, using the adjusted second set of hyperparameters, an updated second machine learning model.

In some non-limiting embodiments or aspects, the plurality of first predictions include a plurality of first prediction scores, wherein the plurality of second predictions include a plurality of second prediction scores, and generating the plurality of groups of samples of the plurality of samples further includes: aligning the plurality of second prediction scores to a same scale as the plurality of first prediction scores; applying an operating point to the plurality of first prediction scores to determine a plurality of first positive predictions and a plurality of first negative predictions; applying the operating point to the plurality of aligned second prediction scores to determine a plurality of second positive predictions and a plurality of second negative predictions; and generating, based on the plurality of first positive predictions, the plurality of first negative predictions, the plurality of second positive predictions, the plurality of second negative predictions, the plurality of labels, and the plurality of groups of samples of the plurality of samples.

In some non-limiting embodiments or aspects, aligning the plurality of second prediction scores to the same scale as the plurality of first prediction scores includes: assigning each first prediction score of the plurality of prediction scores to a first bucket of a plurality of first buckets according to a value of that first prediction score; determining, for each first bucket, a rate of positive first predictions up to the value of the first prediction score assigned to that first bucket; assigning each second prediction score of the plurality of prediction scores to a second bucket of a plurality of second buckets according to a value of that second prediction score; determining, for each second bucket, a rate of positive second predictions up to the value of the second prediction score assigned to that second bucket; and determining, for each second prediction score, an aligned score aligned to the same scale as the plurality of first predictions scores, the value of the first prediction score assigned to the first bucket of the plurality of first buckets for which the rate of positive first predictions is a same rate as the rate of positive second predictions of the second bucket to which that prediction score is assigned.

In some non-limiting embodiments or aspects, generating the plurality of groups of samples of the plurality of samples includes: determining, with the at least one processor, a first group of samples of the plurality of samples for which a first prediction of the plurality of first predictions matches a label of the plurality of labels and a second prediction of the plurality of second predictions matches the label of the plurality of labels; determining, with the at least one processor, a second group of samples of the plurality of samples for which the second prediction of the plurality of second predictions matches the label of the plurality of labels and the first prediction of the plurality of first predictions does not match the label of the plurality of labels; determining, with the at least one processor, a third group of samples of the plurality of samples for which the first prediction of the plurality of first predictions matches the label of the plurality of labels and the second prediction of the plurality of second predictions does not match the label of the plurality of labels; determining, with the at least one processor, a fourth group of samples of the plurality of samples for which the second prediction of the plurality of second predictions does not match the label of the plurality of labels and the first prediction of the plurality of first predictions does not match the label of the plurality of labels; determining, with the at least one processor, a fifth group of samples of the plurality of samples for which the first prediction of the plurality of first predictions does not match the label of the plurality of labels and the second prediction of the plurality of second predictions matches the label of the plurality of labels; and determining, with the at least one processor, a sixth group of samples of the plurality of samples for which the second prediction of the plurality of second predictions does not match the label of the plurality of labels and the first prediction of the plurality of first predictions matches the label of the plurality of labels.

In some non-limiting embodiments or aspects, the first success rate associated with the first machine learning model and the second success rate associated with the second machine learning model are determined according to the following Equations (1) and (2):

$$First Success Rate = \frac{X 1 + Z 1 + λ ( Z 2 )}{X 1 + Y 1 + Z 1 + λ ( X 2 + Y 2 + Z 2 )} \qquad ( 1 )$$

$$Second Success Rate = \frac{X 1 + Y 1 + λ ( Y 2 )}{X 1 + Y 1 + Z 1 + λ ( X 2 + Y 2 + Z 2 )} \qquad ( 2 )$$

where X1 is a number of samples in the first group of samples, Y1 is a number of samples in the second group of samples, Z1 is a number of samples in the third group of samples, X2 is a number of samples in the fourth group of samples, Y2 is a number of samples in the fifth group of samples, Z2 is a number of samples in the sixth group of samples, and λ is a discount factor.

According to some non-limiting embodiments or aspects, provided is a system, including: at least one processor programmed and/or configured to: obtain a plurality of features associated with a plurality of samples and a plurality of labels for the plurality of samples; generate a plurality of first predictions for the plurality of samples by providing, as input to a first machine learning model, a first subset of features of the plurality of features, and receiving, as output from the first machine learning model, the plurality of first predictions for the plurality of samples; generate a plurality of second predictions for the plurality of samples by providing, as input to a second machine learning model, a second subset of features of the plurality of features, and receiving, as output from the second machine learning model, the plurality of second predictions for the plurality of samples; generate, based on the plurality of first predictions, the plurality of second predictions, the plurality of labels, and a plurality of groups of samples of the plurality of samples; determine, based on the plurality of groups of samples, a first success rate associated with the first machine learning model and a second success rate associated with the second machine learning model; and identify, based on the first success rate and the second success rate, a weak point in the second machine learning model associated with a first portion of samples of the plurality of samples including a same first value for a same first feature of the plurality of features and for which the first success rate associated with the first machine learning model is different than the second success rate associated with the second machine learning model.

In some non-limiting embodiments or aspects, at least one of: (i) the first subset of features is different than the second subset of features; (ii) a first set of hyperparameters for a machine learning algorithm used to generate the first machine learning model is different than a second set of hyperparameters for a same machine learning algorithm used to generate the second machine learning model; (iii) a first machine learning algorithm used to generate the first machine learning model is different than a second machine learning algorithm used to generate the second machine learning model; and (iv) a first training data set used to train the first machine learning model is different than a second training data set used to train the second machine learning model.

In some non-limiting embodiments or aspects, the first subset of features is different than the second subset of features, and wherein the at least one processor is programmed and/or configured to identify the weak point in the second machine learning model by: determining a difference in features between the first subset of features and the second subset of features; selecting, based on the same first feature included in the first portion of samples and the difference in features, one or more features of the plurality of features; adjusting the second subset of features based on the selected one or more features; and generating, using the adjusted second subset of features, an updated second machine learning model.

In some non-limiting embodiments or aspects, a first set of hyperparameters for a machine learning algorithm used to generate the first machine learning model is different than a second set of hyperparameters for a same machine learning algorithm used to generate the second machine learning model, and wherein the at least one processor is programmed and/or configured to identify the weak point in the second machine learning model further by: determining a difference in hyperparameters between the first set of hyperparameters and the second set of hyperparameters; determining, based on the same first feature included in the first portion of samples and the difference in the hyperparameters, one or more hyperparameters; adjusting the second set of hyperparameters based on the selected one or more hyperparameters; and generating, using the adjusted second set of hyperparameters, an updated second machine learning model.

In some non-limiting embodiments or aspects, the plurality of first predictions include a plurality of first prediction scores, wherein the plurality of second predictions include a plurality of second prediction scores, and wherein the at least one processor is programmed and/or configured to generate the plurality of groups of samples of the plurality of samples further by: aligning the plurality of second prediction scores to a same scale as the plurality of first prediction scores; applying an operating point to the plurality of first prediction scores to determine a plurality of first positive predictions and a plurality of first negative predictions; applying the operating point to the plurality of aligned second prediction scores to determine a plurality of second positive predictions and a plurality of second negative predictions; and generating, based on the plurality of first positive predictions, the plurality of first negative predictions, the plurality of second positive predictions, the plurality of second negative predictions, the plurality of labels, and the plurality of groups of samples of the plurality of samples.

In some non-limiting embodiments or aspects, the at least one processor is programmed and/or configured to align the plurality of second prediction scores to the same scale as the plurality of first prediction scores by: assigning each first prediction score of the plurality of prediction scores to a first bucket of a plurality of first buckets according to a value of that first prediction score; determining, for each first bucket, a rate of positive first predictions up to the value of the first prediction score assigned to that first bucket; assigning each second prediction score of the plurality of prediction scores to a second bucket of a plurality of second buckets according to a value of that second prediction score; determining, for each second bucket, a rate of positive second predictions up to the value of the second prediction score assigned to that second bucket; and determining, for each second prediction score, an aligned score aligned to the same scale as the plurality of first predictions scores, the value of the first prediction score assigned to the first bucket of the plurality of first buckets for which the rate of positive first predictions is a same rate as the rate of positive second predictions of the second bucket to which that prediction score is assigned.

In some non-limiting embodiments or aspects, the at least one processor is programmed and/or configured to generate the plurality of groups of samples of the plurality of samples by: determining, with the at least one processor, a first group of samples of the plurality of samples for which a first prediction of the plurality of first predictions matches a label of the plurality of labels and a second prediction of the plurality of second predictions matches the label of the plurality of labels; determining, with the at least one processor, a second group of samples of the plurality of samples for which the second prediction of the plurality of second predictions matches the label of the plurality of labels and the first prediction of the plurality of first predictions does not match the label of the plurality of labels; determining, with the at least one processor, a third group of samples of the plurality of samples for which the first prediction of the plurality of first predictions matches the label of the plurality of labels and the second prediction of the plurality of second predictions does not match the label of the plurality of labels; determining, with the at least one processor, a fourth group of samples of the plurality of samples for which the second prediction of the plurality of second predictions does not match the label of the plurality of labels and the first prediction of the plurality of first predictions does not match the label of the plurality of labels; determining, with the at least one processor, a fifth group of samples of the plurality of samples for which the first prediction of the plurality of first predictions does not match the label of the plurality of labels and the second prediction of the plurality of second predictions matches the label of the plurality of labels; and determining, with the at least one processor, a sixth group of samples of the plurality of samples for which the second prediction of the plurality of second predictions does not match the label of the plurality of labels and the first prediction of the plurality of first predictions matches the label of the plurality of labels.

In some non-limiting embodiments or aspects, the first success rate associated with the first machine learning model and the second success rate associated with the second machine learning model are determined according to the following Equations (1) and (2):

$$First Success Rate = \frac{X 1 + Z 1 + λ ( Z 2 )}{X 1 + Y 1 + Z 1 + λ ( X 2 + Y 2 + Z 2 )} \qquad ( 1 )$$

$$Second Success Rate = \frac{X 1 + Y 1 + λ ( Y 2 )}{X 1 + Y 1 + Z 1 + λ ( X 2 + Y 2 + Z 2 )} \qquad ( 2 )$$

where X1 is a number of samples in the first group of samples, Y1 is a number of samples in the second group of samples, Z1 is a number of samples in the third group of samples, X2 is a number of samples in the fourth group of samples, Y2 is a number of samples in the fifth group of samples, Z2 is a number of samples in the sixth group of samples, and λ is a discount factor.

According to some non-limiting embodiments or aspects, provided is a computer program product comprising at least one non-transitory computer-readable medium including program instructions that, when executed by at least one processor, cause the at least one processor to: obtain a plurality of features associated with a plurality of samples and a plurality of labels for the plurality of samples; generate a plurality of first predictions for the plurality of samples by providing, as input to a first machine learning model, a first subset of features of the plurality of features, and receiving, as output from the first machine learning model, the plurality of first predictions for the plurality of samples; generate a plurality of second predictions for the plurality of samples by providing, as input to a second machine learning model, a second subset of features of the plurality of features, and receiving, as output from the second machine learning model, the plurality of second predictions for the plurality of samples; generate, based on the plurality of first predictions, the plurality of second predictions, the plurality of labels, and a plurality of groups of samples of the plurality of samples; determine, based on the plurality of groups of samples, a first success rate associated with the first machine learning model and a second success rate associated with the second machine learning model; and identify, based on the first success rate and the second success rate, a weak point in the second machine learning model associated with a first portion of samples of the plurality of samples including a same first value for a same first feature of the plurality of features and for which the first success rate associated with the first machine learning model is different than the second success rate associated with the second machine learning model.

In some non-limiting embodiments or aspects, at least one of: (i) the first subset of features is different than the second subset of features; (ii) a first set of hyperparameters for a machine learning algorithm used to generate the first machine learning model is different than a second set of hyperparameters for a same machine learning algorithm used to generate the second machine learning model; (iii) a first machine learning algorithm used to generate the first machine learning model is different than a second machine learning algorithm used to generate the second machine learning model; and (iv) a first training data set used to train the first machine learning model is different than a second training data set used to train the second machine learning model.

In some non-limiting embodiments or aspects, the instructions cause the at least one processor to generate the plurality of groups of samples of the plurality of samples by: determining, with the at least one processor, a first group of samples of the plurality of samples for which a first prediction of the plurality of first predictions matches a label of the plurality of labels and a second prediction of the plurality of second predictions matches the label of the plurality of labels; determining, with the at least one processor, a second group of samples of the plurality of samples for which the second prediction of the plurality of second predictions matches the label of the plurality of labels and the first prediction of the plurality of first predictions does not match the label of the plurality of labels; determining, with the at least one processor, a third group of samples of the plurality of samples for which the first prediction of the plurality of first predictions matches the label of the plurality of labels and the second prediction of the plurality of second predictions does not match the label of the plurality of labels; determining, with the at least one processor, a fourth group of samples of the plurality of samples for which the second prediction of the plurality of second predictions does not match the label of the plurality of labels and the first prediction of the plurality of first predictions does not match the label of the plurality of labels; determining, with the at least one processor, a fifth group of samples of the plurality of samples for which the first prediction of the plurality of first predictions does not match the label of the plurality of labels and the second prediction of the plurality of second predictions matches the label of the plurality of labels; and determining, with the at least one processor, a sixth group of samples of the plurality of samples for which the second prediction of the plurality of second predictions does not match the label of the plurality of labels and the first prediction of the plurality of first predictions matches the label of the plurality of labels.

In some non-limiting embodiments or aspects, the first success rate associated with the first machine learning model and the second success rate associated with the second machine learning model are determined according to the following Equations (1) and (2):

$$First Success Rate = \frac{X 1 + Z 1 + λ ( Z 2 )}{X 1 + Y 1 + Z 1 + λ ( X 2 + Y 2 + Z 2 )} \qquad ( 1 )$$

$$Second Success Rate = \frac{X 1 + Y 1 + λ ( Y 2 )}{X 1 + Y 1 + Z 1 + λ ( X 2 + Y 2 + Z 2 )} \qquad ( 2 )$$

where X1 is a number of samples in the first group of samples, Y1 is a number of samples in the second group of samples, Z1 is a number of samples in the third group of samples, X2 is a number of samples in the fourth group of samples, Y2 is a number of samples in the fifth group of samples, Z2 is a number of samples in the sixth group of samples, and λ is a discount factor.

Further non-limiting embodiments or aspects are set forth in the following numbered clauses:

Clause 1. A computer-implemented method, comprising: obtaining, with at least one processor, a plurality of features associated with a plurality of samples and a plurality of labels for the plurality of samples; generating, with the at least one processor, a plurality of first predictions for the plurality of samples by providing, as input to a first machine learning model, a first subset of features of the plurality of features, and receiving, as output from the first machine learning model, the plurality of first predictions for the plurality of samples; generating, with the at least one processor, a plurality of second predictions for the plurality of samples by providing, as input to a second machine learning model, a second subset of features of the plurality of features, and receiving, as output from the second machine learning model, the plurality of second predictions for the plurality of samples; generating, with the at least one processor, based on the plurality of first predictions, the plurality of second predictions, the plurality of labels, and a plurality of groups of samples of the plurality of samples; determining, with the at least one processor, based on the plurality of groups of samples, a first success rate associated with the first machine learning model and a second success rate associated with the second machine learning model; and identifying, with the at least one processor, based on the first success rate and the second success rate, a weak point in the second machine learning model associated with a first portion of samples of the plurality of samples including a same first value for a same first feature of the plurality of features and for which the first success rate associated with the first machine learning model is different than the second success rate associated with the second machine learning model.

Clause 2. The computer-implemented method of clause 1, wherein at least one of: (i) the first subset of features is different than the second subset of features; (ii) a first set of hyperparameters for a machine learning algorithm used to generate the first machine learning model is different than a second set of hyperparameters for a same machine learning algorithm used to generate the second machine learning model; (iii) a first machine learning algorithm used to generate the first machine learning model is different than a second machine learning algorithm used to generate the second machine learning model; and (iv) a first training data set used to train the first machine learning model is different than a second training data set used to train the second machine learning model.

Clause 3. The computer-implemented method of clauses 1 or 2, wherein the first subset of features is different than the second subset of features, and wherein identifying the weak point in the second machine learning model further includes: determining a difference in features between the first subset of features and the second subset of features; selecting, based on the same first feature included in the first portion of samples and the difference in features, one or more features of the plurality of features; adjusting the second subset of features based on the selected one or more features; and generating, using the adjusted second subset of features, an updated second machine learning model.

Clause 4. The computer-implemented method of any of clauses 1-3, wherein a first set of hyperparameters for a machine learning algorithm used to generate the first machine learning model is different than a second set of hyperparameters for a same machine learning algorithm used to generate the second machine learning model, and wherein identifying the weak point in the second machine learning model further includes: determining a difference in hyperparameters between the first set of hyperparameters and the second set of hyperparameters; determining, based on the same first feature included in the first portion of samples and the difference in the hyperparameters, one or more hyperparameters; adjusting the second set of hyperparameters based on the selected one or more hyperparameters; and generating, using the adjusted second set of hyperparameters, an updated second machine learning model.

Clause 5. The computer-implemented method of any of clauses 1-4, wherein the plurality of first predictions include a plurality of first prediction scores, wherein the plurality of second predictions include a plurality of second prediction scores, and wherein generating the plurality of groups of samples of the plurality of samples further includes: aligning the plurality of second prediction scores to a same scale as the plurality of first prediction scores; applying an operating point to the plurality of first prediction scores to determine a plurality of first positive predictions and a plurality of first negative predictions; applying the operating point to the plurality of aligned second prediction scores to determine a plurality of second positive predictions and a plurality of second negative predictions; and generating, based on the plurality of first positive predictions, the plurality of first negative predictions, the plurality of second positive predictions, the plurality of second negative predictions, the plurality of labels, and the plurality of groups of samples of the plurality of samples.

Clause 6. The computer-implemented method of any of clauses 1-5, wherein aligning the plurality of second prediction scores to the same scale as the plurality of first prediction scores includes: assigning each first prediction score of the plurality of prediction scores to a first bucket of a plurality of first buckets according to a value of that first prediction score; determining, for each first bucket, a rate of positive first predictions up to the value of the first prediction score assigned to that first bucket; assigning each second prediction score of the plurality of prediction scores to a second bucket of a plurality of second buckets according to a value of that second prediction score; determining, for each second bucket, a rate of positive second predictions up to the value of the second prediction score assigned to that second bucket; and determining, for each second prediction score, an aligned score aligned to the same scale as the plurality of first predictions scores, the value of the first prediction score assigned to the first bucket of the plurality of first buckets for which the rate of positive first predictions is a same rate as the rate of positive second predictions of the second bucket to which that prediction score is assigned.

Clause 7. The computer-implemented method of any of clauses 1-6, wherein generating the plurality of groups of samples of the plurality of samples includes: determining, with the at least one processor, a first group of samples of the plurality of samples for which a first prediction of the plurality of first predictions matches a label of the plurality of labels and a second prediction of the plurality of second predictions matches the label of the plurality of labels; determining, with the at least one processor, a second group of samples of the plurality of samples for which the second prediction of the plurality of second predictions matches the label of the plurality of labels and the first prediction of the plurality of first predictions does not match the label of the plurality of labels; determining, with the at least one processor, a third group of samples of the plurality of samples for which the first prediction of the plurality of first predictions matches the label of the plurality of labels and the second prediction of the plurality of second predictions does not match the label of the plurality of labels; determining, with the at least one processor, a fourth group of samples of the plurality of samples for which the second prediction of the plurality of second predictions does not match the label of the plurality of labels and the first prediction of the plurality of first predictions does not match the label of the plurality of labels; determining, with the at least one processor, a fifth group of samples of the plurality of samples for which the first prediction of the plurality of first predictions does not match the label of the plurality of labels and the second prediction of the plurality of second predictions matches the label of the plurality of labels; and determining, with the at least one processor, a sixth group of samples of the plurality of samples for which the second prediction of the plurality of second predictions does not match the label of the plurality of labels and the first prediction of the plurality of first predictions matches the label of the plurality of labels.

Clause 8. The computer-implemented method of any of clauses 1-7, wherein the first success rate associated with the first machine learning model and the second success rate associated with the second machine learning model are determined according to the following Equations (1) and (2):

$$First Success Rate = \frac{X 1 + Z 1 + λ ( Z 2 )}{X 1 + Y 1 + Z 1 + λ ( X 2 + Y 2 + Z 2 )} \qquad ( 1 )$$

$$Second Success Rate = \frac{X 1 + Y 1 + λ ( Y 2 )}{X 1 + Y 1 + Z 1 + λ ( X 2 + Y 2 + Z 2 )} \qquad ( 2 )$$

where X1 is a number of samples in the first group of samples, Y1 is a number of samples in the second group of samples, Z1 is a number of samples in the third group of samples, X2 is a number of samples in the fourth group of samples, Y2 is a number of samples in the fifth group of samples, Z2 is a number of samples in the sixth group of samples, and λ is a discount factor.

Clause 9. A system, comprising: at least one processor programmed and/or configured to: obtain a plurality of features associated with a plurality of samples and a plurality of labels for the plurality of samples; generate a plurality of first predictions for the plurality of samples by providing, as input to a first machine learning model, a first subset of features of the plurality of features, and receiving, as output from the first machine learning model, the plurality of first predictions for the plurality of samples; generate a plurality of second predictions for the plurality of samples by providing, as input to a second machine learning model, a second subset of features of the plurality of features, and receiving, as output from the second machine learning model, the plurality of second predictions for the plurality of samples; generate, based on the plurality of first predictions, the plurality of second predictions, the plurality of labels, and a plurality of groups of samples of the plurality of samples; determine, based on the plurality of groups of samples, a first success rate associated with the first machine learning model and a second success rate associated with the second machine learning model; and identify, based on the first success rate and the second success rate, a weak point in the second machine learning model associated with a first portion of samples of the plurality of samples including a same first value for a same first feature of the plurality of features and for which the first success rate associated with the first machine learning model is different than the second success rate associated with the second machine learning model.

Clause 10. The system of clause 9, wherein at least one of: (i) the first subset of features is different than the second subset of features; (ii) a first set of hyperparameters for a machine learning algorithm used to generate the first machine learning model is different than a second set of hyperparameters for a same machine learning algorithm used to generate the second machine learning model; (iii) a first machine learning algorithm used to generate the first machine learning model is different than a second machine learning algorithm used to generate the second machine learning model; and (iv) a first training data set used to train the first machine learning model is different than a second training data set used to train the second machine learning model.

Clause 11. The system of clauses 9 or 10, wherein the first subset of features is different than the second subset of features, and wherein the at least one processor is programmed and/or configured to identify the weak point in the second machine learning model by: determining a difference in features between the first subset of features and the second subset of features; selecting, based on the same first feature included in the first portion of samples and the difference in features, one or more features of the plurality of features; adjusting the second subset of features based on the selected one or more features; and generating, using the adjusted second subset of features, an updated second machine learning model.

Clause 12. The system of any of clauses 9-11, wherein a first set of hyperparameters for a machine learning algorithm used to generate the first machine learning model is different than a second set of hyperparameters for a same machine learning algorithm used to generate the second machine learning model, and wherein the at least one processor is programmed and/or configured to identify the weak point in the second machine learning model further by: determining a difference in hyperparameters between the first set of hyperparameters and the second set of hyperparameters; determining, based on the same first feature included in the first portion of samples and the difference in the hyperparameters, one or more hyperparameters; adjusting the second set of hyperparameters based on the selected one or more hyperparameters; and generating, using the adjusted second set of hyperparameters, an updated second machine learning model.

Clause 13. The system of any of clauses 9-12, wherein the plurality of first predictions include a plurality of first prediction scores, wherein the plurality of second predictions include a plurality of second prediction scores, and wherein the at least one processor is programmed and/or configured to generate the plurality of groups of samples of the plurality of samples further by: aligning the plurality of second prediction scores to a same scale as the plurality of first prediction scores; applying an operating point to the plurality of first prediction scores to determine a plurality of first positive predictions and a plurality of first negative predictions; applying the operating point to the plurality of aligned second prediction scores to determine a plurality of second positive predictions and a plurality of second negative predictions; and generating, based on the plurality of first positive predictions, the plurality of first negative predictions, the plurality of second positive predictions, the plurality of second negative predictions, the plurality of labels, and the plurality of groups of samples of the plurality of samples.

Clause 14. The system of any of clauses 9-13, wherein the at least one processor is programmed and/or configured to align the plurality of second prediction scores to the same scale as the plurality of first prediction scores by: assigning each first prediction score of the plurality of prediction scores to a first bucket of a plurality of first buckets according to a value of that first prediction score; determining, for each first bucket, a rate of positive first predictions up to the value of the first prediction score assigned to that first bucket; assigning each second prediction score of the plurality of prediction scores to a second bucket of a plurality of second buckets according to a value of that second prediction score; determining, for each second bucket, a rate of positive second predictions up to the value of the second prediction score assigned to that second bucket; and determining, for each second prediction score, an aligned score aligned to the same scale as the plurality of first predictions scores, the value of the first prediction score assigned to the first bucket of the plurality of first buckets for which the rate of positive first predictions is a same rate as the rate of positive second predictions of the second bucket to which that prediction score is assigned.

Clause 15. The system of any of clauses 9-14, wherein the at least one processor is programmed and/or configured to generate the plurality of groups of samples of the plurality of samples by: determining, with the at least one processor, a first group of samples of the plurality of samples for which a first prediction of the plurality of first predictions matches a label of the plurality of labels and a second prediction of the plurality of second predictions matches the label of the plurality of labels; determining, with the at least one processor, a second group of samples of the plurality of samples for which the second prediction of the plurality of second predictions matches the label of the plurality of labels and the first prediction of the plurality of first predictions does not match the label of the plurality of labels; determining, with the at least one processor, a third group of samples of the plurality of samples for which the first prediction of the plurality of first predictions matches the label of the plurality of labels and the second prediction of the plurality of second predictions does not match the label of the plurality of labels; determining, with the at least one processor, a fourth group of samples of the plurality of samples for which the second prediction of the plurality of second predictions does not match the label of the plurality of labels and the first prediction of the plurality of first predictions does not match the label of the plurality of labels; determining, with the at least one processor, a fifth group of samples of the plurality of samples for which the first prediction of the plurality of first predictions does not match the label of the plurality of labels and the second prediction of the plurality of second predictions matches the label of the plurality of labels; and determining, with the at least one processor, a sixth group of samples of the plurality of samples for which the second prediction of the plurality of second predictions does not match the label of the plurality of labels and the first prediction of the plurality of first predictions matches the label of the plurality of labels.

Clause 16. The system of any of clauses 9-15, wherein the first success rate associated with the first machine learning model and the second success rate associated with the second machine learning model are determined according to the following Equations (1) and (2):

$$First Success Rate = \frac{X 1 + Z 1 + λ ( Z 2 )}{X 1 + Y 1 + Z 1 + λ ( X 2 + Y 2 + Z 2 )} \qquad ( 1 )$$

$$Second Success Rate = \frac{X 1 + Y 1 + λ ( Y 2 )}{X 1 + Y 1 + Z 1 + λ ( X 2 + Y 2 + Z 2 )} \qquad ( 2 )$$

where X1 is a number of samples in the first group of samples, Y1 is a number of samples in the second group of samples, Z1 is a number of samples in the third group of samples, X2 is a number of samples in the fourth group of samples, Y2 is a number of samples in the fifth group of samples, Z2 is a number of samples in the sixth group of samples, and λ is a discount factor.

Clause 17. A computer program product comprising at least one non-transitory computer-readable medium including program instructions that, when executed by at least one processor, cause the at least one processor to: obtain a plurality of features associated with a plurality of samples and a plurality of labels for the plurality of samples; generate a plurality of first predictions for the plurality of samples by providing, as input to a first machine learning model, a first subset of features of the plurality of features, and receiving, as output from the first machine learning model, the plurality of first predictions for the plurality of samples; generate a plurality of second predictions for the plurality of samples by providing, as input to a second machine learning model, a second subset of features of the plurality of features, and receiving, as output from the second machine learning model, the plurality of second predictions for the plurality of samples; generate, based on the plurality of first predictions, the plurality of second predictions, the plurality of labels, and a plurality of groups of samples of the plurality of samples; determine, based on the plurality of groups of samples, a first success rate associated with the first machine learning model and a second success rate associated with the second machine learning model; and identify, based on the first success rate and the second success rate, a weak point in the second machine learning model associated with a first portion of samples of the plurality of samples including a same first value for a same first feature of the plurality of features and for which the first success rate associated with the first machine learning model is different than the second success rate associated with the second machine learning model.

Clause 18. The computer program product of clause 17, wherein at least one of: (i) the first subset of features is different than the second subset of features; (ii) a first set of hyperparameters for a machine learning algorithm used to generate the first machine learning model is different than a second set of hyperparameters for a same machine learning algorithm used to generate the second machine learning model; (iii) a first machine learning algorithm used to generate the first machine learning model is different than a second machine learning algorithm used to generate the second machine learning model; and (iv) a first training data set used to train the first machine learning model is different than a second training data set used to train the second machine learning model.

Clause 19. The computer program product of clauses 17 or 18, wherein the instructions cause the at least one processor to generate the plurality of groups of samples of the plurality of samples by: determining, with the at least one processor, a first group of samples of the plurality of samples for which a first prediction of the plurality of first predictions matches a label of the plurality of labels and a second prediction of the plurality of second predictions matches the label of the plurality of labels; determining, with the at least one processor, a second group of samples of the plurality of samples for which the second prediction of the plurality of second predictions matches the label of the plurality of labels and the first prediction of the plurality of first predictions does not match the label of the plurality of labels; determining, with the at least one processor, a third group of samples of the plurality of samples for which the first prediction of the plurality of first predictions matches the label of the plurality of labels and the second prediction of the plurality of second predictions does not match the label of the plurality of labels; determining, with the at least one processor, a fourth group of samples of the plurality of samples for which the second prediction of the plurality of second predictions does not match the label of the plurality of labels and the first prediction of the plurality of first predictions does not match the label of the plurality of labels; determining, with the at least one processor, a fifth group of samples of the plurality of samples for which the first prediction of the plurality of first predictions does not match the label of the plurality of labels and the second prediction of the plurality of second predictions matches the label of the plurality of labels; and determining, with the at least one processor, a sixth group of samples of the plurality of samples for which the second prediction of the plurality of second predictions does not match the label of the plurality of labels and the first prediction of the plurality of first predictions matches the label of the plurality of labels.

Clause 20. The computer program product of any of clauses 17-19, wherein the first success rate associated with the first machine learning model and the second success rate associated with the second machine learning model are determined according to the following Equations (1) and (2):

$$First Success Rate = \frac{X 1 + Z 1 + λ ( Z 2 )}{X 1 + Y 1 + Z 1 + λ ( X 2 + Y 2 + Z 2 )} \qquad ( 1 )$$

$$Second Success Rate = \frac{X 1 + Y 1 + λ ( Y 2 )}{X 1 + Y 1 + Z 1 + λ ( X 2 + Y 2 + Z 2 )} \qquad ( 2 )$$

where X1 is a number of samples in the first group of samples, Y1 is a number of samples in the second group of samples, Z1 is a number of samples in the third group of samples, X2 is a number of samples in the fourth group of samples, Y2 is a number of samples in the fifth group of samples, Z2 is a number of samples in the sixth group of samples, and λ is a discount factor.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of limits. As used in the specification and the claims, the singular form of “a,” “an,” and “the” include plural referents unless the context clearly dictates otherwise.

### BRIEF DESCRIPTION OF THE DRAWINGS

Additional advantages and details are explained in greater detail below with reference to the exemplary embodiments that are illustrated in the accompanying schematic figures, in which:

FIG. 1 is a diagram of non-limiting embodiments or aspects of an environment in which systems, devices, products, apparatus, and/or methods, described herein, may be implemented;

FIG. 2 is a diagram of non-limiting embodiments or aspects of components of one or more devices and/or one or more systems of FIG. 1;

FIG. 3 is a flowchart of non-limiting embodiments or aspects of a process for identifying weak points in a predictive model;

FIG. 4 is a flow chart of an implementation of non-limiting embodiments or aspects of a process for identifying weak points in a predictive model;

FIG. 5 is a diagram of an implementation of non-limiting embodiments or aspects of subsets of samples for calculating a performance metric;

FIG. 6 is a graph illustrating an example scenario in which a new model makes incorrect predictions for some instances or samples for which an old model makes correct predictions;

FIG. 7 is a graph illustrating relative success rates for example models;

FIG. 8 is graph illustrating disagreements between example models;

FIG. 9 is a graph illustrating relative success rates between example models;

FIG. 10 is a graph illustrating disagreements between example models;

FIG. 11 is a graph illustrating relative success rates between example models; and

FIG. 12 is a graph illustrating disagreements between example models.

### DETAILED DESCRIPTION

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

Some non-limiting embodiments or aspects may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

As used herein, the term “communication” may refer to the reception, receipt, transmission, transfer, provision, and/or the like, of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

It will be apparent that systems and/or methods, described herein, can be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code, it being understood that software and hardware can be designed to implement the systems and/or methods based on the description herein.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computing devices operated by or on behalf of a transaction service provider, such as a transaction processing server executing one or more software applications. A transaction processing system may include one or more processors and, in some non-limiting embodiments, may be operated by or on behalf of a transaction service provider.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases and/or the like) such that they may be used to conduct a transaction without directly using the original account identifier. In some examples, an original account identifier, such as a PAN, may be associated with a plurality of tokens for different individuals or purposes.

As used herein, the terms “issuer institution,” “portable financial device issuer,” “issuer,” or “issuer bank” may refer to one or more entities that provide one or more accounts to a user (e.g., a customer, a consumer, an entity, an organization, and/or the like) for conducting transactions (e.g., payment transactions), such as initiating credit card payment transactions and/or debit card payment transactions. For example, an issuer institution may provide an account identifier, such as a PAN, to a user that uniquely identifies one or more accounts associated with that user. The account identifier may be embodied on a portable financial device, such as a physical financial instrument (e.g., a payment card), and/or may be electronic and used for electronic payments. In some non-limiting embodiments or aspects, an issuer institution may be associated with a bank identification number (BIN) that uniquely identifies the issuer institution. As used herein “issuer institution system” may refer to one or more computer systems operated by or on behalf of an issuer institution, such as a server computer executing one or more software applications. For example, an issuer institution system may include one or more authorization servers for authorizing a payment transaction.

As used herein, the term “merchant” may refer to an individual or entity that provides goods and/or services, or access to goods and/or services, to users (e.g. customers) based on a transaction (e.g. a payment transaction). As used herein, the terms “merchant” or “merchant system” may also refer to one or more computer systems, computing devices, and/or software application operated by or on behalf of a merchant, such as a server computer executing one or more software applications. A “point-of-sale (POS) system,” as used herein, may refer to one or more computers and/or peripheral devices used by a merchant to engage in payment transactions with users, including one or more card readers, near-field communication (NFC) receivers, radio frequency identification (RFID) receivers, and/or other contactless transceivers or receivers, contact-based receivers, payment terminals, computers, servers, input devices, and/or other like devices that can be used to initiate a payment transaction. A POS system may be part of a merchant system. A merchant system may also include a merchant plug-in for facilitating online, Internet-based transactions through a merchant webpage or software application. A merchant plug-in may include software that runs on a merchant server or is hosted by a third-party for facilitating such online transactions.

As used herein, the term “mobile device” may refer to one or more portable electronic devices configured to communicate with one or more networks. As an example, a mobile device may include a cellular phone (e.g., a smartphone or standard cellular phone), a portable computer (e.g., a tablet computer, a laptop computer, etc.), a wearable device (e.g., a watch, pair of glasses, lens, clothing, and/or the like), a personal digital assistant (PDA), and/or other like devices. The terms “client device” and “user device,” as used herein, refer to any electronic device that is configured to communicate with one or more servers or remote devices and/or systems. A client device or user device may include a mobile device, a network-enabled appliance (e.g., a network-enabled television, refrigerator, thermostat, and/or the like), a computer, a POS system, and/or any other device or system capable of communicating with a network.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a PDA, and/or other like devices. A computing device may also be a desktop computer or other form of non-mobile computer.

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Pay®, Android Pay®, Apple Pay®, Samsung Pay®, and/or other like electronic payment systems. In some non-limiting examples, an issuer bank may be an electronic wallet provider.

As used herein, the term “payment device” may refer to a portable financial device, an electronic payment device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a PDA, a pager, a security card, a computer, an access card, a wireless terminal, a transponder, and/or the like. In some non-limiting embodiments or aspects, the payment device may include volatile or nonvolatile memory to store information (e.g., an account identifier, a name of the account holder, and/or the like).

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “acquirer” may refer to an entity licensed by the transaction service provider and/or approved by the transaction service provider to originate transactions using a portable financial device of the transaction service provider. Acquirer may also refer to one or more computer systems operated by or on behalf of an acquirer, such as a server computer executing one or more software applications (e.g., “acquirer server”). An “acquirer” may be a merchant bank, or in some cases, the merchant system may be the acquirer. The transactions may include original credit transactions (OCTs) and account funding transactions (AFTs). The acquirer may be authorized by the transaction service provider to sign merchants of service providers to originate transactions using a portable financial device of the transaction service provider. The acquirer may contract with payment facilitators to enable the facilitators to sponsor merchants. The acquirer may monitor compliance of the payment facilitators in accordance with regulations of the transaction service provider. The acquirer may conduct due diligence of payment facilitators and ensure that proper due diligence occurs before signing a sponsored merchant. Acquirers may be liable for all transaction service provider programs that they operate or sponsor. Acquirers may be responsible for the acts of its payment facilitators and the merchants it or its payment facilitators sponsor.

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like operated by or on behalf of a payment gateway.

As used herein, the term “application programming interface” (API) may refer to computer code that allows communication between different systems or (hardware and/or software) components of systems. For example, an API may include function calls, functions, subroutines, communication protocols, fields, and/or the like usable and/or accessible by other systems or other (hardware and/or software) components of systems.

As used herein, the term “user interface” or “graphical user interface” refers to a generated display, such as one or more graphical user interfaces (GUIs) with which a user may interact, either directly or indirectly (e.g., through a keyboard, mouse, touchscreen, etc.).

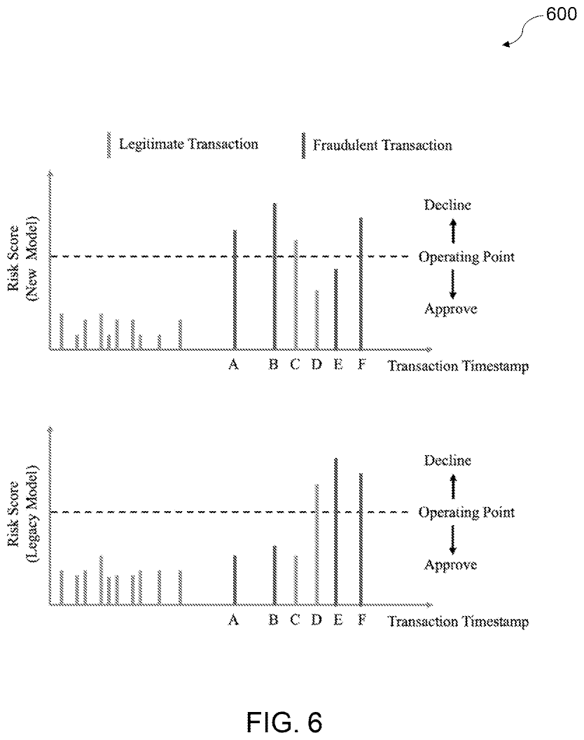

After retraining or updating a model, the new model may be expected to outperform the older model in regions of interest. However, the new model may often make incorrect decisions on some instances where the old model still performs well and makes correct decisions. Referring now to FIG. 6, FIG. 6 is a graph illustrating an example scenario 600 in which a new model makes incorrect predictions for some instances or samples for which an old model makes correct predictions. As shown in FIG. 6, the upper panel or graph represents the new model, and the lower panel or graph represents the old or legacy model. A darker bar indicates a fraudulent transaction, and a lighter bar indicates a legitimate transaction. The dashed line represents an operating point, or score cutoff. For a production model, particularly a fraud detection model, an operating point or score cutoff is associated with the model, and, based on a comparison of a prediction score output by the fraud detection model to the operating point, an issuer system determines whether to decline or approve a transaction. For example, assuming a risk score is between 1 to 1000, where the higher the risk score, the riskier a transaction; and an operating point is 800, all transactions above the score 800 may be declined, and all transactions below the score 800 may be approved.

Still referring to FIG. 6, among a last six transactions, marked as A, B, C, D, E, and F, four of the transactions are fraudulent (A, B, E, F) and two of the transactions are legitimate (C, D). The upper panel or graph shows that, at a given operating point or score cutoff, the new model correctly captures three fraudulent transactions, A, B, and F, but misses one fraudulent transaction, E. The new model also incorrectly declines a legitimate transaction, C. The lower panel or graph shows that, at the given operating point or score cutoff, the old model correctly captures two fraudulent transactions, E and F, but misses fraudulent transactions, A and B. The old model also incorrectly declines a legitimate transaction, D.

In the example scenario shown in FIG. 6, although the old model misses more fraudulent transactions, the old model captures a fraudulent transaction that is missed by the new model, transaction E. The old model also does not make a mistake on a legitimate transaction, transaction C, which the new model incorrectly declines. The example scenario shown in FIG. 6 thus illustrates that there is a need to identify why an old model sometimes performs better than a new model, which may help business partners in an organization gain confidence in adopting the new model, as well as help modelers to improve the new model in future releases.

However, it is a non-trivial task to assess model performance and understand when and why a new model fails compared to an old model. Existing evaluation and benchmark methods of model performance heavily rely on aggregated and over-simplified metrics, such as Area Under Curve (AUC), and are unable to pinpoint the weak points in a predictive model.

Provided are improved systems, devices, products, apparatus, and/or methods for host-based purchase restrictions that obtain a plurality of features associated with a plurality of samples and a plurality of labels for the plurality of samples; generate a plurality of first predictions for the plurality of samples by providing, as input to a first machine learning model, a first subset of features of the plurality of features, and receiving, as output from the first machine learning model, the plurality of first predictions for the plurality of samples; generate a plurality of second predictions for the plurality of samples by providing, as input to a second machine learning model, a second subset of features of the plurality of features, and receiving, as output from the second machine learning model, the plurality of second predictions for the plurality of samples; generate, based on the plurality of first predictions, the plurality of second predictions, the plurality of labels, and a plurality of groups of samples of the plurality of samples; determine, based on the plurality of groups of samples, a first success rate associated with the first machine learning model and a second success rate associated with the second machine learning model; and identify, based on the first success rate and the second success rate, a weak point in the second machine learning model associated with a first portion of samples of the plurality of samples including a same first value for a same first feature of the plurality of features and for which the first success rate associated with the first machine learning model is different than the second success rate associated with the second machine learning model.

In this way, non-limiting embodiments or aspects provide a novel evaluation network structure including a pair of models in which one model serves as a mirror of another model, and a novel performance metric, success rate, that is a relative performance metric, incorporates a cost for an incorrect decision, and focuses on instances leading to contradictory decisions between the two models at a given operating point, thereby providing a simple but effective means for pinpointing the weak points in a predictive model without needing to know internal architectures of the pair of models, as well as providing for adjusting features and/or hyperparameters of the predictive model based on the identified weak points for generating an updated version of the predictive model to improve the performance thereof with respect to the identified weak point.

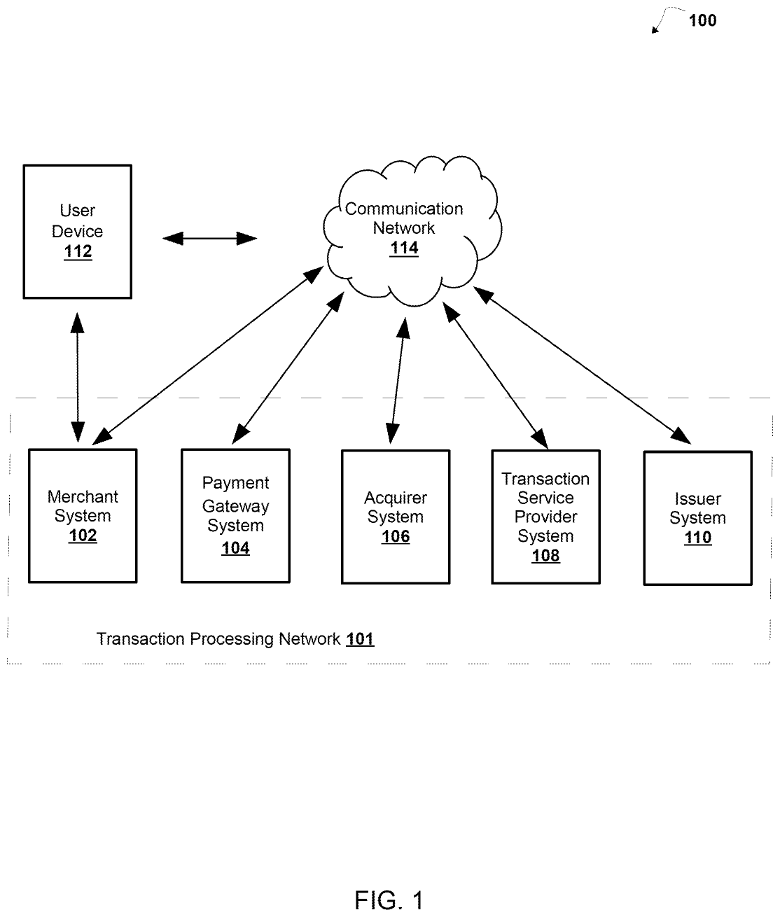

Referring now to FIG. 1, FIG. 1 is a diagram of an example environment 100 in which devices, systems, methods, and/or products described herein, may be implemented. As shown in FIG. 1, environment 100 includes transaction processing network 101, which may include merchant system 102, payment gateway system 104, acquirer system 106, transaction service provider system 108, issuer system 110, user device 112, and/or communication network 114. Transaction processing network 101, merchant system 102, payment gateway system 104, acquirer system 106, transaction service provider system 108, issuer system 110, and/or user device 112 may interconnect (e.g., establish a connection to communicate, etc.) via wired connections, wireless connections, or a combination of wired and wireless connections.

Merchant system 102 may include one or more devices capable of receiving information and/or data from payment gateway system 104, acquirer system 106, transaction service provider system 108, issuer system 110, and/or user device 112 via communication network 114 and/or communicating information and/or data to payment gateway system 104, acquirer system 106, transaction service provider system 108, issuer system 110, and/or user device 112 via communication network 114. Merchant system 102 may include a device capable of receiving information and/or data from user device 112 via a communication connection (e.g., an NFC communication connection, an RFID communication connection, a Bluetooth® communication connection, etc.) with user device 112, and/or communicating information and/or data to user device 112 via the communication connection. For example, merchant system 102 may include a computing device, such as a server, a group of servers, a client device, a group of client devices, and/or other like devices. In some non-limiting embodiments or aspects, merchant system 102 may be associated with a merchant as described herein. In some non-limiting embodiments or aspects, merchant system 102 may include one or more devices, such as computers, computer systems, and/or peripheral devices capable of being used by a merchant to conduct a payment transaction with a user. For example, merchant system 102 may include a POS device and/or a POS system.

Payment gateway system 104 may include one or more devices capable of receiving information and/or data from merchant system 102, acquirer system 106, transaction service provider system 108, issuer system 110, and/or user device 112 via communication network 114 and/or communicating information and/or data to merchant system 102, acquirer system 106, transaction service provider system 108, issuer system 110, and/or user device 112 via communication network 114. For example, payment gateway system 104 may include a computing device, such as a server, a group of servers, and/or other like devices. In some non-limiting embodiments or aspects, payment gateway system 104 is associated with a payment gateway as described herein.

Acquirer system 106 may include one or more devices capable of receiving information and/or data from merchant system 102, payment gateway system 104, transaction service provider system 108, issuer system 110, and/or user device 112 via communication network 114 and/or communicating information and/or data to merchant system 102, payment gateway system 104, transaction service provider system 108, issuer system 110, and/or user device 112 via communication network 114. For example, acquirer system 106 may include a computing device, such as a server, a group of servers, and/or other like devices. In some non-limiting embodiments or aspects, acquirer system 106 may be associated with an acquirer as described herein.

Transaction service provider system 108 may include one or more devices capable of receiving information and/or data from merchant system 102, payment gateway system 104, acquirer system 106, issuer system 110, and/or user device 112 via communication network 114 and/or communicating information and/or data to merchant system 102, payment gateway system 104, acquirer system 106, issuer system 110, and/or user device 112 via communication network 114. For example, transaction service provider system 108 may include a computing device, such as a server (e.g., a transaction processing server, etc.), a group of servers, and/or other like devices. In some non-limiting embodiments or aspects, transaction service provider system 108 may be associated with a transaction service provider as described herein. In some non-limiting embodiments or aspects, transaction service provider system 108 may include and/or access one or more internal and/or external databases including transaction data.

Issuer system 110 may include one or more devices capable of receiving information and/or data from merchant system 102, payment gateway system 104, acquirer system 106, transaction service provider system 108, and/or user device 112 via communication network 114 and/or communicating information and/or data to merchant system 102, payment gateway system 104, acquirer system 106, transaction service provider system 108, and/or user device 112 via communication network 114. For example, issuer system 110 may include a computing device, such as a server, a group of servers, and/or other like devices. In some non-limiting embodiments or aspects, issuer system 110 may be associated with an issuer institution as described herein. For example, issuer system 110 may be associated with an issuer institution that issued a payment account or instrument (e.g., a credit account, a debit account, a credit card, a debit card, etc.) to a user (e.g., a user associated with user device 112, etc.).

In some non-limiting embodiments or aspects, transaction processing network 101 includes a plurality of systems in a communication path for processing a transaction. For example, transaction processing network 101 can include merchant system 102, payment gateway system 104, acquirer system 106, transaction service provider system 108, and/or issuer system 110 in a communication path (e.g., a communication path, a communication channel, a communication network, etc.) for processing an electronic payment transaction. As an example, transaction processing network 101 can process (e.g., initiate, conduct, authorize, etc.) an electronic payment transaction via the communication path between merchant system 102, payment gateway system 104, acquirer system 106, transaction service provider system 108, and/or issuer system 110.

User device 112 may include one or more devices capable of receiving information and/or data from merchant system 102, payment gateway system 104, acquirer system 106, transaction service provider system 108, and/or issuer system 110 via communication network 114 and/or communicating information and/or data to merchant system 102, payment gateway system 104, acquirer system 106, transaction service provider system 108, and/or issuer system 110 via communication network 114. For example, user device 112 may include a client device and/or the like. In some non-limiting embodiments or aspects, user device 112 may be capable of receiving information (e.g., from merchant system 102, etc.) via a short range wireless communication connection (e.g., an NFC communication connection, an RFID communication connection, a Bluetooth® communication connection, and/or the like), and/or communicating information (e.g., to merchant system 102, etc.) via a short range wireless communication connection.

In some non-limiting embodiments or aspects, user device 112 may include one or more applications associated with user device 112, such as an application stored, installed, and/or executed on user device 112 (e.g., a mobile device application, a native application for a mobile device, a mobile cloud application for a mobile device, an electronic wallet application, a peer-to-peer payment transfer application, a merchant application, an issuer application, etc.).

Communication network 114 may include one or more wired and/or wireless networks. For example, communication network 114 may include a cellular network (e.g., a long-term evolution (LTE) network, a third generation (3G) network, a fourth generation (4G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of devices and systems shown in FIG. 1 is provided as an example. There may be additional devices and/or systems, fewer devices and/or systems, different devices and/or systems, or differently arranged devices and/or systems than those shown in FIG. 1. Furthermore, two or more devices and/or systems shown in FIG. 1 may be implemented within a single device and/or system, or a single device and/or system shown in FIG. 1 may be implemented as multiple, distributed devices and/or systems. Additionally or alternatively, a set of devices and/or systems (e.g., one or more devices or systems) of environment 100 may perform one or more functions described as being performed by another set of devices and/or systems of environment 100.

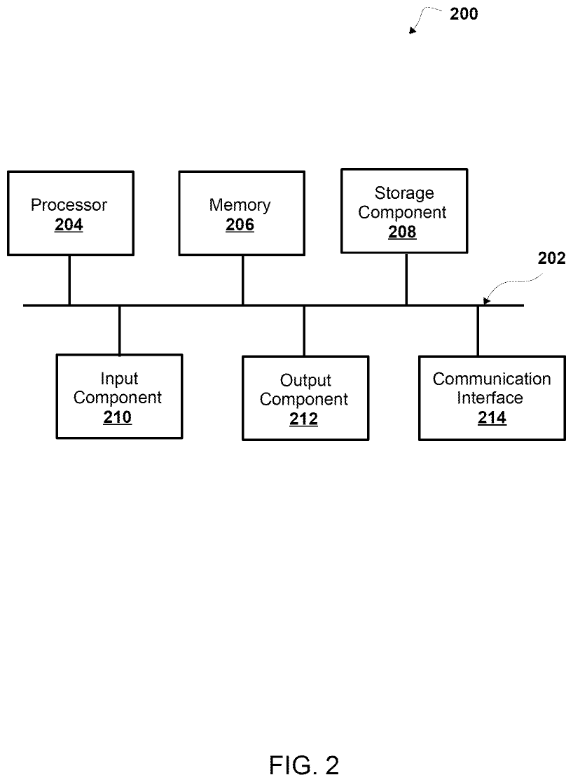

Referring now to FIG. 2, FIG. 2 is a diagram of example components of a device 200. Device 200 may correspond to one or more devices of merchant system 102, one or more devices of payment gateway system 104, one or more devices of acquirer system 106, one or more devices of transaction service provider system 108, one or more devices of issuer system 110, and/or user device 112 (e.g., one or more devices of a system of user device 112, etc.). In some non-limiting embodiments or aspects, one or more devices of merchant system 102, one or more devices of payment gateway system 104, one or more devices of acquirer system 106, one or more devices of transaction service provider system 108, one or more devices of issuer system 110, and/or user device 112 (e.g., one or more devices of a system of user device 112, etc.) may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments or aspects, processor 204 may be implemented in hardware, software, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software.

Memory 206 and/or storage component 208 may include data storage or one or more data structures (e.g., a database, etc.). Device 200 may be capable of receiving information from, storing information in, communicating information to, or searching information stored in the data storage or one or more data structures in memory 206 and/or storage component 208.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

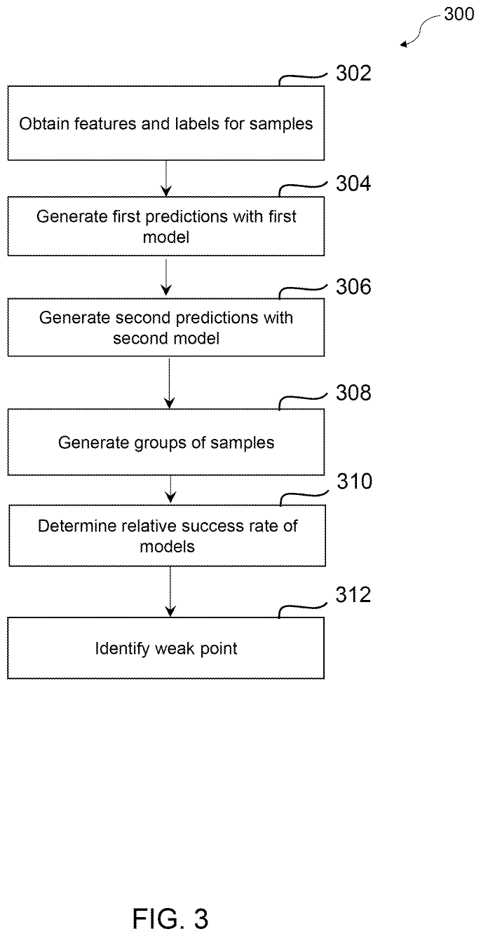

Referring now to FIG. 3, FIG. 3 is a flowchart of non-limiting embodiments or aspects of a process 300 for identifying weak points in a predictive model. In some non-limiting embodiments or aspects, one or more of the steps of process 300 may be performed (e.g., completely, partially, etc.) by transaction service provider system 108 (e.g., one or more devices of transaction service provider system 108). In some non-limiting embodiments or aspects, one or more of the steps of process 300 may be performed (e.g., completely, partially, etc.) by another device or a group of devices separate from or including transaction service provider system 108, such as, (e.g., one or more devices of merchant system 102), payment gateway system 104 (e.g., one or more devices of payment gateway system 104), acquirer system 106 (e.g., one or more devices of acquirer system 106), transaction service provider system 108 (e.g., one or more devices of transaction service provider system 108, etc.), issuer system 110 (e.g., one or more devices of issuer system 110), and/or user device 112.

As shown in FIG. 3, at step 302, process 300 includes obtaining a plurality of features associated with a plurality of samples and a plurality of labels for the plurality of samples. For example, transaction service provider system 108 may obtain a plurality of features associated with a plurality of samples and a plurality of labels (e.g., true labels, false labels, etc.) for the plurality of samples.

In some non-limiting embodiments or aspects, a sample may be associated with a transaction. For example, a feature associated with a transaction sample may include a transaction parameter, a metric calculated based on a plurality of transaction parameters associated with a plurality of transactions, and/or one or more embeddings generated therefrom. As an example, a transaction parameter may include an account identifier (e.g., a PAN, etc.), a transaction amount, a transaction date and/or time, a type of products and/or services associated with the transaction, a conversion rate of currency, a type of currency, a merchant type, a merchant name, a merchant location, a merchant, a merchant category group (MCG), a merchant category code (MCC), an AA score, a card acceptor identifier, a card acceptor country/state/region, a number of declined transactions in a time period, a fraud rate in a location (e.g., in a zip code, etc.), a merchant embedding, and/or the like. In such an example, a label for a transaction may include a fraud label (e.g., an indication that the transaction is fraudulent, a true label, etc.) or a non-fraud label (e.g., an indication that the transaction is not fraudulent, a false label, etc.).

As shown in FIG. 3, at step 304, process 300 includes generating, with a first machine learning model, a plurality of first predictions for the plurality of samples. For example, transaction service provider system 108 may generate a plurality of first predictions for the plurality of samples by providing, as input to a first machine learning model, a first subset of features of the plurality of features, and receiving, as output from the first machine learning model, the plurality of first predictions for the plurality of samples. As an example, the first machine learning model may be trained using or configured with a first subset of features of the plurality of features, a first set of hyperparameters, a first machine learning algorithm, and/or a first training data set.

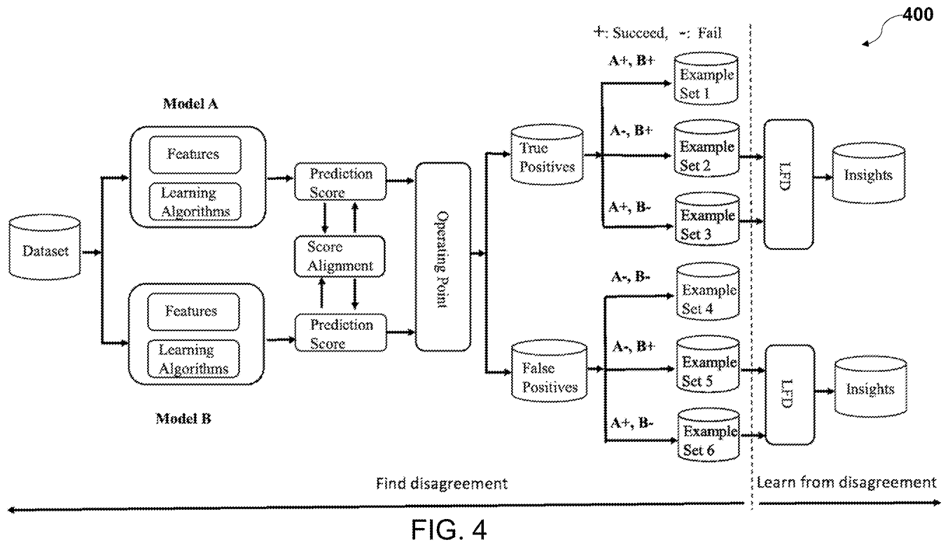

Referring also to FIG. 4, FIG. 4 is a flowchart of an implementation 400 of non-limiting embodiments or aspects of a process for identifying weak points in a predictive model. As shown in FIG. 4, a first machine learning model (Model A), which has been trained using or configured with a first subset of features of the plurality of features, a first set of hyperparameters, a first machine learning algorithm, and/or a first training data set, may be configured to receive, as input, a first subset of features of a plurality of features associated with a dataset including a plurality of samples (e.g., transaction samples, etc.), and the plurality of samples may be associated with a plurality of labels (e.g., true labels, fraud labels, false labels, non-fraud labels, etc.).

As shown in FIG. 3, at step 306, process 300 includes generating, with a second machine learning model, a plurality of second predictions for the plurality of samples. For example, transaction service provider system 108 may generate a plurality of second predictions for the plurality of samples by providing, as input to a second machine learning model, a second subset of features of the plurality of features, and receiving, as output from the second machine learning model, the plurality of second predictions for the plurality of samples. As an example, the second machine learning model may be trained using or configured with a second subset of features of the plurality of features, a second set of hyperparameters, a second machine learning algorithm, and/or a second training data set.

Referring again to FIG. 4, a second machine learning model (Model B), which has been trained using or configured with a second subset of features of the plurality of features, a second set of hyperparameters, a second machine learning algorithm, and/or a second training data set, may be configured to receive, as input, a second subset of features of a plurality of features associated with the dataset including the plurality of samples (e.g., transaction samples, etc.) associated with the plurality of labels (e.g., true labels, fraud labels, false labels, non-fraud labels, etc.).

In some non-limiting embodiments or aspects, at least one of: (i) the first subset of features is different than the second subset of features; (ii) the first set of hyperparameters for a machine learning algorithm used to generate the first machine learning model is different than the second set of hyperparameters for a same machine learning algorithm used to generate the second machine learning model; (iii) the first machine learning algorithm used to generate the first machine learning model is different than the second machine learning algorithm used to generate the second machine learning model; and (iv) the first training data set used to train the first machine learning model is different than the second training data set used to train the second machine learning model. For example, the first machine learning model (Model A) may include a legacy model (e.g., an older model, etc.) and the second machine learning model (Model B) may include a new model (e.g., an updated version of the legacy model, etc.). As an example, the first subset of features for the first machine learning model (Model A) may include a number of declined transactions in a period of time (e.g., in a previous 30 minutes, etc.), a fraud rate in a location (e.g., in a zip code), and/or the like, and the second machine learning model (Model B) may include merchant embeddings, and/or the like. In such an example, the first machine learning algorithm in the first machine learning model (Model A) may include a logistic regression or gradient boosting trees, and the second machine learning algorithm in the second machine learning model (Model B) may include a deep neural network.

As shown in FIG. 3, at step 308, process 300 includes generating a plurality of groups of samples of the plurality of samples. For example, transaction service provider system 108 may generate, based on the plurality of first predictions, the plurality of second predictions, the plurality of labels, and a plurality of groups of samples of the plurality of samples. As an example, transaction service provider system 108 may group the samples into groups of true positives or true frauds and groups of false positives or false frauds (e.g., false declines, etc.) according to whether one of, each of, or neither of the first predictions of first machine learning model and the second predictions of second machine learning model match the labels for the samples.

In some non-limiting embodiments or aspects, generating the plurality of groups of samples of the plurality of samples includes: determining, with the at least one processor, a first group of samples of the plurality of samples for which a first prediction of the plurality of first predictions matches a label of the plurality of labels and a second prediction of the plurality of second predictions matches the label of the plurality of labels; determining, with the at least one processor, a second group of samples of the plurality of samples for which the second prediction of the plurality of second predictions matches the label of the plurality of labels and the first prediction of the plurality of first predictions does not match the label of the plurality of labels; determining, with the at least one processor, a third group of samples of the plurality of samples for which the first prediction of the plurality of first predictions matches the label of the plurality of labels and the second prediction of the plurality of second predictions does not match the label of the plurality of labels; determining, with the at least one processor, a fourth group of samples of the plurality of samples for which the second prediction of the plurality of second predictions does not match the label of the plurality of labels and the first prediction of the plurality of first predictions does not match the label of the plurality of labels; determining, with the at least one processor, a fifth group of samples of the plurality of samples for which the first prediction of the plurality of first predictions does not match the label of the plurality of labels and the second prediction of the plurality of second predictions matches the label of the plurality of labels; and determining, with the at least one processor, a sixth group of samples of the plurality of samples for which the second prediction of the plurality of second predictions does not match the label of the plurality of labels and the first prediction of the plurality of first predictions matches the label of the plurality of labels.

In some non-limiting embodiments or aspects, the plurality of first predictions include a plurality of first prediction scores, and the plurality of second predictions include a plurality of second prediction scores. For example, transaction service provider system 108 may generate the plurality of groups of samples of the plurality of samples by: aligning the plurality of second prediction scores to a same scale as the plurality of first prediction scores; applying an operating point to the plurality of first prediction scores to determine a plurality of first positive predictions and a plurality of first negative predictions; applying the operating point to the plurality of aligned second prediction scores to determine a plurality of second positive predictions and a plurality of second negative predictions; and generating, based on the plurality of first positive predictions, the plurality of first negative predictions, the plurality of second positive predictions, the plurality of second negative predictions, the plurality of labels, and the plurality of groups of samples of the plurality of samples. As an example, and referring again to FIG. 4, after receiving the first prediction scores and the second prediction scores, transaction service provider system 108 may align the first prediction scores and the second prediction scores to ensure that each of the first prediction scores and the second prediction scores are on a same scale (e.g., to ensure that the scores from the two models represent the same level of risk, etc.). For example, score alignment may convert disparate score values from different ranges into a same risk assessment by only modifying score values and not changing the rank order (and hence the model performance).

In some non-limiting embodiments or aspects, transaction service provider system 108 may align the plurality of second prediction scores to the same scale as the plurality of first prediction scores (or vice-versa) by assigning each first prediction score of the plurality of prediction scores to a first bucket of a plurality of first buckets according to a value of that first prediction score; determining, for each first bucket, a rate of positive first predictions up to the value of the first prediction score assigned to that first bucket; assigning each second prediction score of the plurality of prediction scores to a second bucket of a plurality of second buckets according to a value of that second prediction score; determining, for each second bucket, a rate of positive second predictions up to the value of the second prediction score assigned to that second bucket; and determining, for each second prediction score, an aligned score aligned to the same scale as the plurality of first predictions scores, the value of the first prediction score assigned to the first bucket of the plurality of first buckets for which the rate of positive first predictions is a same rate as the rate of positive second predictions of the second bucket to which that prediction score is assigned.

For example, the first prediction scores (Model A scores) may be divided into 1000 buckets, where the first bucket corresponds to a score 0, the second bucket corresponds to a score 1, and the 1000th bucket corresponds to a score 999. In each bucket, the transaction decline rate up to the current score for that bucket may be calculated, which creates a two-column table (Table A) where the first column is the first prediction or Model A score, and the second column is the transaction decline rate of the bucket to which that Model A score is assigned. The same process may be repeated for the second prediction scores (Model B scores), in which the second prediction scores (Model B scores) may be divided into 1000 buckets, where the first bucket corresponds to a score 0, the second bucket corresponds to a score 1, and the 1000th bucket corresponds to a score 999, and in each bucket, the transaction decline rate up to the current score for that bucket may be calculated, resulting in another two-column table (Table B). The first column of Table B is the Model B score, and the second column is the transaction decline rate of the bucket to which that Model B score is assigned. Given a score at a transaction decline rate in Table A, denoted as Score A, transaction service provider system 108 matches the same transaction decline rate in Table B with its corresponding score, denoted as Score B. The Score B is the aligned Model B score. For example, a Model B score with a value of Score B may have the same level of risk as a Model A score with a value of Score A. In practice, it is possible that the transaction decline rate or the score is not available in Table A or Table B and, in such a scenario, the transaction decline rate or score may be calculated using interpolation.

After aligning the plurality of second prediction scores to a same scale as the plurality of first prediction scores (or vice-versa), transaction service provider system 108 may apply an operating point to the plurality of first prediction scores to determine a plurality of first positive predictions and a plurality of first negative predictions and apply the operating point to the plurality of aligned second prediction scores to determine a plurality of second positive predictions and a plurality of second negative predictions. Transaction service provider system 108 may generate, based on the plurality of first positive predictions, the plurality of first negative predictions, the plurality of second positive predictions, the plurality of second negative predictions, the plurality of labels, and the plurality of groups of samples of the plurality of samples.

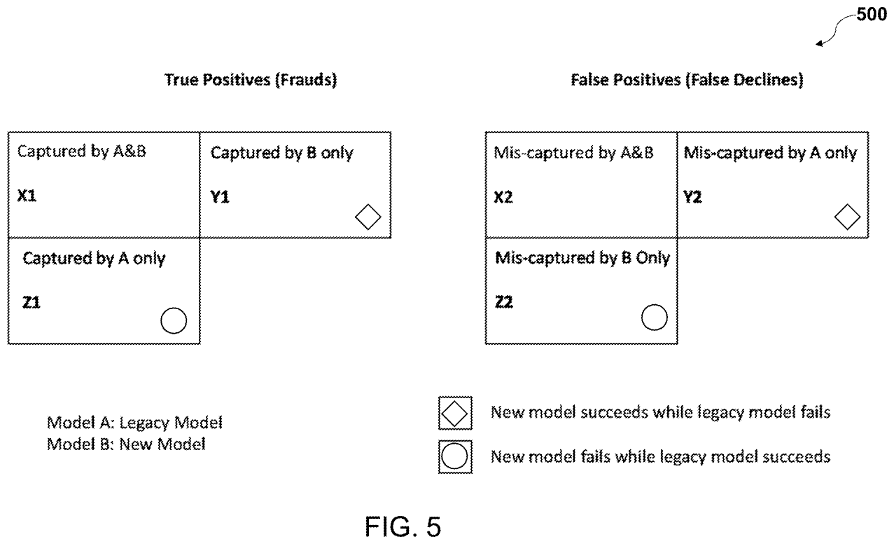

Referring also to FIG. 5, FIG. 5 is a diagram of an implementation 500 of non-limiting embodiments or aspects of subsets of samples for calculating a performance metric. As shown in FIGS. 4 and 5, transaction service provider system 108 may generate the plurality of groups of samples of the plurality of samples by dividing the plurality of samples into six groups of samples represented by Example Sets 1-6 in FIG. 4 and the corresponding six boxes labeled as groups X1, Y1, Z1, X2, Y2, and Z2 in FIG. 5, with three boxes representing groups of true positives or true frauds and three boxes representing groups of false positives or false declines. In FIG. 4, the two symbols “+”, and “−” are used to indicate whether or not a model is making correct predictions or decisions, where “+” means that a model is making correct decisions according to the labels, while “−” means that a model is making incorrect predictions or decisions according to the labels

For example, for the true positives or true frauds: A+, B+ indicates that, for a sample labeled as a positive or fraudulent transaction, both Model A and Model B successfully predict or capture the sample or fraudulent transaction; A−, B+ indicates that, for a sample labeled as a positive or fraudulent transaction, Model A fails to predict or capture the sample as a positive or fraudulent transaction, but Model B predicts or captures the sample as a positive or fraudulent transaction; and A+, B− indicates that, for a sample labeled as a positive or fraudulent transaction, model A predicts or captures the sample as a positive or fraudulent transaction, but Model B fails to predict or capture the sample as a positive or fraudulent transaction.

As an example, for the false positives or false declines: A−, B− indicates that, for a sample labeled as a negative or legitimate (non-fraudulent) transaction, each of Model A and Model B are making mistakes by predicting or flagging the sample as a positive or fraudulent transaction; A−, B+ indicates that, for a sample labeled as a negative or legitimate (non-fraudulent) transaction, Model A is making a mistake by predicting or flagging the sample as a positive or fraudulent transaction, while Model B is making a correct decision by predicting the sample a negative or legitimate (non-fraudulent) transaction; and A+, B− indicates that, for a sample labeled as a negative or legitimate (non-fraudulent) transaction Model A is making a correct decision by predicting the sample a negative or legitimate (non-fraudulent) transaction, but Model B is making a mistake by predicting or flagging the sample as a positive or fraudulent transaction.

As shown in FIG. 5, group X1 may include samples associated with positive or fraud labels and predictions A+, B+, group Y1 may include samples associated with positive or fraud labels and predictions A−, B+, group Z1 may include samples associated with positive or fraud labels and predictions A+, B−, group X2 may include samples associated with negative or non-fraud labels and predictions A−, B−, group Y2 may include samples associated with negative or non-fraud labels and predictions A−, B+, and group Z2 may include samples associated with negative or non-fraud labels and predictions A+, B−. As also shown in FIG. 5, a diamond symbol in a box indicates that only Model B makes a correct prediction or decision for the samples in that group, a circle symbol indicates only Model A makes a correct prediction or decision for the samples in that group, and no symbol indicates that each of Model A and Model B either made all correct predictions or decisions for the samples in that group or made all incorrect predictions or decisions for the samples in that group.

For example, a first group of samples X1 of the plurality of samples may include samples for which a first prediction of the plurality of first predictions matches a label of the plurality of labels, and a second prediction of the plurality of second predictions matches the label of the plurality of labels, a second group of samples Y1 of the plurality of samples may include samples for which the second prediction of the plurality of second predictions matches the label of the plurality of labels and the first prediction of the plurality of first predictions does not match the label of the plurality of labels, a third group of samples Z1 of the plurality of samples may include samples for which the first prediction of the plurality of first predictions matches the label of the plurality of labels, and the second prediction of the plurality of second predictions does not match the label of the plurality of labels, a fourth group of samples X2 of the plurality of samples may include samples for which the second prediction of the plurality of second predictions does not match the label of the plurality of labels and the first prediction of the plurality of first predictions does not match the label of the plurality of labels, a fifth group of samples Y2 of the plurality of samples may include samples for which the first prediction of the plurality of first predictions does not match the label of the plurality of labels and the second prediction of the plurality of second predictions matches the label of the plurality of labels, and a sixth group of samples Z2 of the plurality of samples may include samples for which the second prediction of the plurality of second predictions does not match the label of the plurality of labels, and the first prediction of the plurality of first predictions matches the label of the plurality of labels.

As shown in FIG. 3, at step 310, process 300 includes determining a relative success rate of a first machine learning model and a second machine learning model. For example, transaction service provider system 108 may determine a relative success rate of the first machine learning model and the second machine learning model. As an example, transaction service provider system 108 may determine a relative success rate including a first success rate associated with the first machine learning model and a second success rate associated with the second machine learning model. For example, transaction service provider system 108 may determine, based on the plurality of groups of samples, a first success rate associated with the first machine learning model and a second success rate associated with the second machine learning model.

A first success rate (Model A success rate) associated with a first machine learning model may be determined according to the following Equation (1):

$$First Success Rate ( Model A ) = \frac{X 1 + Z 1 + λ ( Z 2 )}{X 1 + Y 1 + Z 1 + λ ( X 2 + Y 2 + Z 2 )} \qquad ( 1 )$$

where X1 is a number of samples and/or an amount associated with the number of samples (e.g., a transaction amount, etc.) in a first group of samples X1, Y1 is a number of samples and/or an amount associated with the number of samples (e.g., a transaction amount, etc.) in a second group of samples Y1, Z1 is a number of samples and/or an amount associated with the number of samples (e.g., a transaction amount, etc.) in a third group of samples Z1, X2 is a number of samples and/or an amount associated with the number of samples (e.g., a transaction amount, etc.) in a fourth group of samples X2, Y2 is a number of samples and/or an amount associated with the number of samples (e.g., a transaction amount, etc.) in a fifth group of samples Y2, Z2 is a number of samples and/or an amount associated with the number of samples (e.g., a transaction amount, etc.) in the sixth group of samples, and wherein λ is a discount factor.

A second success rate (Model B success rate) associated with a second machine learning model may be determined according to the following Equation (2):

$$Second Success Rate ( Model B ) = \frac{X 1 + Y 1 + λ ( Y 2 )}{X 1 + Y 1 + Z 1 + λ ( X 2 + Y 2 + Z 2 )} \qquad ( 2 )$$

where X1 is the number of samples and/or the amount associated with the number of samples (e.g., a transaction amount, etc.) in the first group of samples X1, Y1 is the number of samples and/or the amount associated with the number of samples (e.g., a transaction amount, etc.) in the second group of samples Y1, Z1 is the number of samples and/or the amount associated with the number of samples (e.g., a transaction amount, etc.) in the third group of samples Z1, X2 is the number of samples and/or the amount associated with the number of samples (e.g., a transaction amount, etc.) in the fourth group of samples X2, Y2 is the number of samples and/or the amount associated with the number of samples (e.g., a transaction amount, etc.) in the fifth group of samples Y2, Z2 is the number of samples and/or an amount associated with the number of samples (e.g., a transaction amount, etc.) in a sixth group of samples Z2, and λ is the discount factor.

In this way, for Equation (1) for the first success rate associated with the first machine learning model (Model A), group X1 includes frauds captured by both Model A and Model B, causing X1 to be counted as a success for the first machine learning model (Model A). Group Z1 includes frauds captured exclusively by the first machine learning model (Model A), causing Z1 to also be counted as a success for the first machine learning model (Model A). Group Z2 includes false positives from the second machine learning model (Model B) but not from the first machine learning model (Model A), causing Z2 to be counted as a success for the first machine learning model (Model A). For example, group Z2 includes legitimate transactions, and the second machine learning model (Model B) mistakenly predicts the legitimate group Z2 transactions as fraud and declines the legitimate group Z2 transactions, but the first machine learning model (Model A) correctly predicts the group Z2 transactions as legitimate and authorizes the group Z2 transactions. Because the first machine learning model (Model A) does not make mistakes on the group Z2 transactions, the first machine learning model (Model A) is given credit in the relative performance metric for correctly predicting these transactions. On the other hand, because a loss from a false positive is not as serious as a loss from a fraud, a discount λ may be applied to the credit given to the first machine learning model (Model A) for the group Z2 transactions. A denominator of Equation (1) for the first success rate associated with the first machine learning model (Model A) may include a sum of all fraud and false positives with the discount λ. Equation (2) for the second success rate associated with the second machine learning model (Model B) is calculated in a similar manner by replacing Z1 and Z2 in the numerator with Y1 and Y2 to give the second machine learning model (Model B) credit for the fraudulent group Y1 transactions captured only by the second machine learning model (Model B) and the legitimate group Y2 transactions correctly predicted by only the second machine learning model (Model B).

Accordingly, non-limiting embodiments or aspects of the present disclosure provide a relative success rate that is a relative performance metric designed for evaluating the performance of a pair of models and that adds a cost to an incorrect decision. This relative performance metric enables comparing a pair of models at a given operating point or score cutoff by learning from disagreement (LFD) between the two models to find a difference between the two models (e.g., a weak point in one of the two models with respect to the other of the two models, etc.). For example, if a fraudulent transaction is captured by Model A, the transaction may be counted as a success of Model A, and if a legitimate transaction is declined by Model B, but not by Model A, the transaction may also be counted as a success of model A, but with a discount factor. This relative performance metric further adds a cost to an incorrect decision. For example, if a consumer spends $100 for a pair of shoes with a credit card, for the $100, a card issuer may receive $2, an acquiring bank may receive $0.50, and the transaction service provider may receive $0.18 from the two banks, resulting in the merchant only receiving $97.50 of the $100. If this $100 transaction is fraudulent, and a fraud prediction model predicts the transaction as fraud and declines the transaction, $100 is saved, and each of the parties to the transaction are happy. However, if the $100 transaction is legitimate, and the fraud prediction model declines the transaction by mistake, the card issuer, the acquiring bank, and the transaction service provider do not receive any payment, the merchant loses revenue, and the consumer has a bad experience. The relative performance metric thus adds a cost to an incorrect decision to capture this loss.

As shown in FIG. 3, at step 312, process 300 includes identifying a weak point in a model. For example, transaction service provider system 108 may identify, based on the relative success rate, a weak point in one of the first machine learning model and the second machine learning model. As an example, transaction service provider system 108 may identify, based on the first success rate and the second success rate, a weak point in the second machine learning model associated with a first portion of samples of the plurality of samples including a same first value for a same first feature of the plurality of features and for which the first success rate associated with the first machine learning model is different than (e.g., greater than, less than, etc.) the second success rate associated with the second machine learning model. As an example, transaction service provider system 108 may identify, based on the first success rate and the second success rate, the weak point in the second machine learning model associated with a second portion of samples of the plurality of samples including a same second value for the same first feature of the plurality of features and for which the first success rate associated with the first machine learning model is different than (e.g., less than, greater than, etc.) the second success rate associated with the second machine learning model.

A same feature of the plurality of features may include any feature associated with a sample (e.g., any feature associated with a transaction sample, etc.), such as a transaction parameter, a metric calculated based on a plurality of transaction parameters associated with a plurality of transactions, and/or one or more embeddings generated therefrom. For example, the same feature may include transaction amount, transaction date and/or time, type of products and/or services associated with the transaction, type of currency, merchant type, merchant name, merchant location, merchant category group (MCG), merchant category code (MCC), and/or the like. As an example, a same value for the same feature may include a same merchant location (e.g., a same merchant country, etc.), such as each transaction sample being associated with a merchant location including a value of “Brazil”, and/or the like. In such an example, transaction service provider system 108 may identify, based on the first success rate and the second success rate, the weak point in the second machine learning model as a merchant location in Brazil based on identifying that the first success rate associated with the first machine learning model is greater than the second success rate associated with the second machine learning model for the transaction samples having a merchant location in Brazil.

In some non-limiting embodiments or aspects, the first subset of features for the first machine learning model is different than the second subset of features for the second machine learning model, and transaction service provider system 108 may identify the weak point in the second machine learning model by: determining a difference in features between the first subset of features and the second subset of features; selecting, based on the same first feature included in the first portion of samples and the difference in features, one or more features of the plurality of features; adjusting the second subset of features based on the selected one or more features; and generating, using the adjusted second subset of features, an updated second machine learning model. For example, transaction service provider system 108 may identify a weak point in the second machine learning model as transaction samples having a same value for a same merchant location (e.g., transaction samples having a merchant location in Brazil, etc.), and transaction service provider system 108 may select, according to the difference in the features between the first subset of features and the second subset of features (and/or one or more predetermined rules linking input features, etc.), one or more features (e.g., new features, different features, etc.) to add to the second subset of features or to replace one or more second features in the second subset of features to use in generating an updated version of the second machine learning model to improve the performance of the second machine learning model in predicting transaction samples having the same value for the same feature (e.g., a merchant location in Brazil, etc.) identified as the weak point in the second machine learning model.

In some non-limiting embodiments or aspects, a first set of hyperparameters for a machine learning algorithm used to generate the first machine learning model is different than a second set of hyperparameters for a same machine learning algorithm used to generate the second machine learning model, and transaction service provider system 108 may identify the weak point in the second machine learning model by: determining a difference in hyperparameters between the first set of hyperparameters and the second set of hyperparameters; determining, based on the same first feature included in the first portion of samples and the difference in the hyperparameters, one or more hyperparameters; adjusting the second set of hyperparameters based on the selected one or more hyperparameters; and generating, using the adjusted second set of hyperparameters, an updated second machine learning model. For example, transaction service provider system 108 may identify a weak point in the second machine learning model as transaction samples having a same value for a same merchant location (e.g., transaction samples having a merchant location in Brazil, etc.), and transaction service provider system 108 may determine, according to the difference in the hyperparameters between the first set of hyperparameters and the second set of hyperparameters (and/or one or more predetermined rules linking hyperparameters to features, etc.), one or more hyperparameters (e.g., new hyperparameters, different hyperparameters, etc.) to adjust in the second set of hyperparameters to use in generating an updated version of the second machine learning model to improve the performance of the second machine learning model in predicting transaction samples having the same value for the same feature (e.g., a merchant location in Brazil, etc.) identified as the weak point in the second machine learning model.

A goal of LFD is to gain insights that enable business partners and modelers to have a deep understanding of a model. Insights should be actionable: business partners should be able to use these insights to convince potential clients to adopt a new model, and modelers should be able to use these learned insights to improve their models.

Insights can be learned and presented using various forms, for example, by revealing problems and suggesting feasible solutions as described by Zachary C. Lipton and Jacob Steinhardt in the paper entitled “Troubling trends in machine learning scholarship”, arXiv preprint arXiv:1807.03341 (2018), and by Maurizio Ferrari Dacrema, Paolo Cremonesi, and Dietmar Jannach in the paper entitled “Are we really making much progress? A worrying analysis of recent neural recommendation approaches”, arXiv preprint arXiv:1907.06902v3 (2019), the entire contents of each of which are incorporated by reference.

Non-limiting embodiments or aspects of the present disclosure may approach this problem from a feature analysis/recommendation perspective. For example, transaction service provider system 108 may create a large feature poll, known as “oracle features” as described by Stefanos Poulis, Sanjoy Dasgupta in the paper entitled “Learning with feature feedback: from theory to practice” In Proceedings of the 20th International Conference on Artificial Intelligence and Statistics (2017) at pages 1104-1113, the entire contents of which are incorporated by reference. Transaction service provider system 108 may investigate which of these features contribute to the disagreement between two models at a given operating point, which recognizes that, if a feature (or a set of features) has the ability to discriminate those disagreed instances, this feature carries information that is overlooked in the features used in one of the current two models, or in each of the models. As an example, the available features in one of the current two models or in each of the models cannot support reliable differentiation between classes, and thus cause the disagreements. Incorporating this new feature into the two models provides new discriminative power to one of the models or both models, and thus helps mitigate the disagreements.

Transaction service provider system 108 may create oracle features based on an understanding on the data and years of domain knowledge. For example, transaction service provider system 108 may use automatic tools as disclosed by: (i) James Max Kanter and Kalyan Veeramachaneni in the paper entitled “Deep feature synthesis: Towards automating data science endeavors” In IEEE International Conference on Data Science and Advanced Analytics (DSAA) (2015) at pages 1-10; (ii) Gilad Katz, Eui Chul, Richard Shin, and Dawn Song in the paper entitled “ExploreKit: Automatic feature generation and selection” In International Conference on Data Mining (2016) at pages 979-984; and/or (iii) Yuanfei Luo, Mengshuo Wang, Hao Zhou, Quanming Yao, WeiWei Tu, Yuqiang Chen, Qiang Yang, and Wenyuan Dai in the paper entitled “AutoCross: Automatic feature crossing for tabular data in real-world applications” arXiv preprint arXiv:1904.12857 (2019), the entire contents of each of which are incorporated by reference, and/or by discovering strong discriminative features through understanding properties of the data that distinguish one class from another, disclosed by Kayur Patel, Steven M. Drucker, James Fogarty, Ashish Kapoor, and Desney S. Tan in the paper entitled “Using multiple models to understand data” In Proceedings of the Twenty-Second International Joint Conference on Artificial Intelligence (2011), the entire contents of which are incorporated by reference.

To see which oracle features contribute most to the disagreement at a given point, transaction service provider system 108 may train two XGBoost trees, one on instances in Group Z1 and Group Y1, and another on instances in Group Y2 and Group Z2 as described by Junpeng Wang, Liang Wang, Yan Zheng, Chin-Chia Michael Yeh, Shubham Jain, and Wei Zhang in the paper entitled “Learning-from-disagreement: A model comparison and visual analytics framework” Submitted to IEEE Transactions on Visualization and Computer Graphics, the entire contents of which are incorporated by reference, and rank feature importance based on their SHAP values as described by Scott M. Lundberg and Su-In Lee in the paper entitled “A unified approach to interpreting model predictions, Advances in Neural Information Processing Systems” (2017) and by Scott M. Lundberg, Gabriel G. Erion, and Su-In Lee in the paper entitled “Consistent individualized feature attribution for tree ensembles” arXiv preprint arXiv:1802.03888 (2018), the entire contents of each of which are incorporated by reference. Because XGBboost trees need all features to be numerical, all categorical features are converted into numerical features using some feature encoding mechanism (e.g., historic clickthrough rate from a publisher's website, historic decline rate from a merchant, etc.).

Non-limiting embodiments or aspects of the present disclosure provide an alternative method to measure the discriminative power of a feature, without the need to train a model. This method, which may be referred to as robust information value (RIV), removes two major flaws from the traditional information value (IV) used in the credit card industry as described by Naeem Siddiqi in the paper entitled “Credit Risk Scorecards: Developing and Implementing Intelligent Credit Scoring”, John Wiley & Sons, Hoboken, New Jersey (2016), the entire contents of which are incorporated by reference. Given that LFD analyzes disagreed instances at a given score cutoff based on a large number of oracle features, and the given score cutoff can vary for different clients, RIV greatly speeds up the process of discovering important features that cause the disagreement.

Traditionally, IV is calculated according to the following Equations (3) and (4):

$${WOE}_{i} = log ( \frac{{E}_{i}}{{NE}_{i}} ) - log ( \frac{E}{NE} ) \qquad ( 3 )$$

$$IV = {\sum }_{i = 1}^{C} [ ( \frac{{E}_{i}}{E} - \frac{{NE}_{i}}{NE} ) \times {WOE}_{i} ] \qquad ( 4 )$$

where C is number of categories in a feature, Eᵢ is the number of events in category i, NEᵢ is the number of non-events in category i, E is the total number of events, and NE is the total number of non-events.

Equation (3) refers to weigh-of-evidence (WOE). A basic property of WOE can be thought of as the average of the whole population. For example, WOE may indicate that, a final belief in a hypothesis (e.g., a click is correctly classified by Model A but not by Model B) is equal to an initial belief plus the weight of evidence of whatever evidence is presented. As an example, a final belief that a click is correctly classified by Model A but not by Model B may equal an initial belief that any click may be correctly classified by Model A but not by Model B, plus the weight of evidence, such as its occurrence in a Site-ID where Model A performs better than Model B based on training data.

WOE can be positive, negative, or zero. Positive WOE causes a belief, in the form of log-odds, to increase; negative WOE results in a decrease in a belief; and a WOE of zero leaves the log-odds unaffected.

Consider Group Z1 and Y1, where instances in Group Z1 have a label 0, and instances in Group Y1 have a label 1. The oracle feature is Site-ID which itself may include hundreds of site-IDs (categories). If a click occurs in a site-ID whose WOE value is 0.60, this is interpreted as evidence of 0.60 for this click belonging to Group Z1 (that is, there is more evidence to indicate that this instance is correctly classified by model A but not by model B, compared with before the site-ID where the click occurs is known). If, however, the click occurs in a site-ID whose WOE value is −0.58, this is interpreted as evidence of 0.58 against this click belonging to Group Z1.

After obtaining WOE, the calculation of information value (IV) in Equation (4) is straightforward. Notice that IV is non-negative because the sights of Eᵢ/E−NEᵢ/NE and WOEᵢ are the same. WOE and IV are widely used in the credit scoring industry and provide a simple yet powerful way of making sense of a feature. WOE is recently used in a prediction difference analysis method for visualizing the response of a deep neural network for a given input.

There are two flaws in the traditional WOE and IV formulas. The first flaw is that they treat categories in a feature equally, ignoring the fact that small counts can lead to less robust statistics. For instance, for the Site-ID feature, suppose one site-ID has one click and two non-clicks, while another site-ID has 100 clicks and 200 non-clicks. Both site-IDs have a click rate of 0.5, but there is less confidence in the click rate of the first site-ID than that in the second site-ID. The second flaw is that IV has a bias toward giving a higher value for features including more categories. Because each element on the right side of Equation (4) can never have a negative value, adding a large number of elements each having a tiny value can lead to a larger sum.

Non-limiting embodiments or aspects of the present disclosure overcome these two flaws by introducing the following new formulas, inspired by the m-estimate method for probability estimate, according to the following Equations (5) and (6):

$${RWOE}_{i} = log ( \frac{{E}_{i} + m \times \frac{E}{E + NE}}{{NE}_{i} + m \times \frac{NE}{E + NE}} ) - log ( \frac{E}{NE} ) \qquad ( 5 )$$

$$RIV = {\sum }_{i = 1}^{C} [ ( \frac{{E}_{i} + m \times \frac{E}{E + NE}}{E} - \frac{{NE}_{i} + m \times \frac{NE}{E + NE}}{NE} ) \times {WOE}_{i} ] \qquad ( 6 )$$

where m is smoothing parameter. These two formulas may be referred to as robust weight-of-evidence (RWOE) and robust information value (RIV), respectively.

An idea of RWOE and RIV may be that, in each category of a feature, m*(E/(E+NE) events and m*(NE/(E+NE) non-events are “borrowed”, given that E/(E+NE) and NE/(E+NE) actually represent event rate and non-event rate, respectively. How many events and non-events that are borrowed may depend on a confidence in the events and non-event counts in a category. If the counts are small (e.g., fail to satisfy a threshold, etc.) more events and non-events may be borrowed by setting a larger m, or vice-versa. A very large m may make the first part on the right side of Equation (5) become log (E/NE), leading to a zero WOE value (e.g., the global average WOE, which is zero). As a result, this category may not contribute anything to the IV calculation of this feature, which effectively mitigates the bias exhibited in the traditional IV formula.

Notice that WOE and IV are for a single feature. It is well realized that features that look irrelevant in isolation may be relevant in combination. This is especially true in click-through rate (CTR) prediction and transaction anomaly detection where the strongest features indicative of the event being classified are those that are best capturing interactions among several dimensions. A majority of oracle features may be designed for capturing interactions. Because these features often involve several dimensions (e.g., the concatenation of User-ID, Site-ID, and Advertiser-ID may result in a three-dimensional feature), many categories in these features tend to have small counts.

### Example Application Case 1: CTR Prediction

LFD may always be working on a pair of models. In this application case, the pair of models consist of a logistic regression model and a graph neural network model known as FiGNN. The logistic regression model, named Model A, includes 21 raw features, which are encoded using “hash trick” one-hot encoding, and is trained using the FTRL (follow the regularized leader) online learning algorithm. The graph neural network model, named Model B, uses a novel graph structure aiming at capturing feature interactions from the 21 raw features automatically.

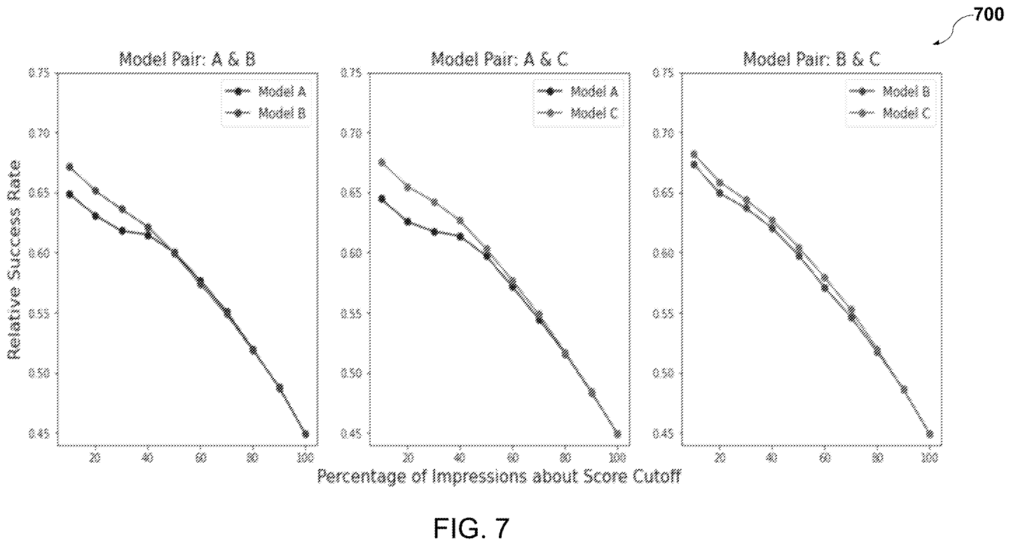

Model A may be viewed in this pair as a simpler model because it is a linear model including only 21 raw features, and Model B is a more advanced model because it has a more complex structure designed for discovering feature interactions automatically. Referring now to FIG. 7, which is a graph 700 showing relative success rates of example models, the left panel of FIG. 7 shows the relative success rate of this pair of models. An interesting observation is that, as the penetration goes deeper, the advantage of FiGNN over the simple logistic regression model vanishes. This suggests that, if access to a large audience is desired, it does not matter whether a simple or an advanced model should be used. A benefit of using a more advanced model comes from working on the population with high scores, as often the case for CTR prediction and transaction anomaly detection.

Also referred to in FIG. 7 is a logistic regression model, named Model C, which is trained using 70 features recommended by the LFD framework with FTRL. Again, the features are encoded using “hash trick” one-hot encoding. It can be seen that, Model C offers noticeable improvements compared with both Model A (middle panel) and Model B (right panel), especially for the high-score population.

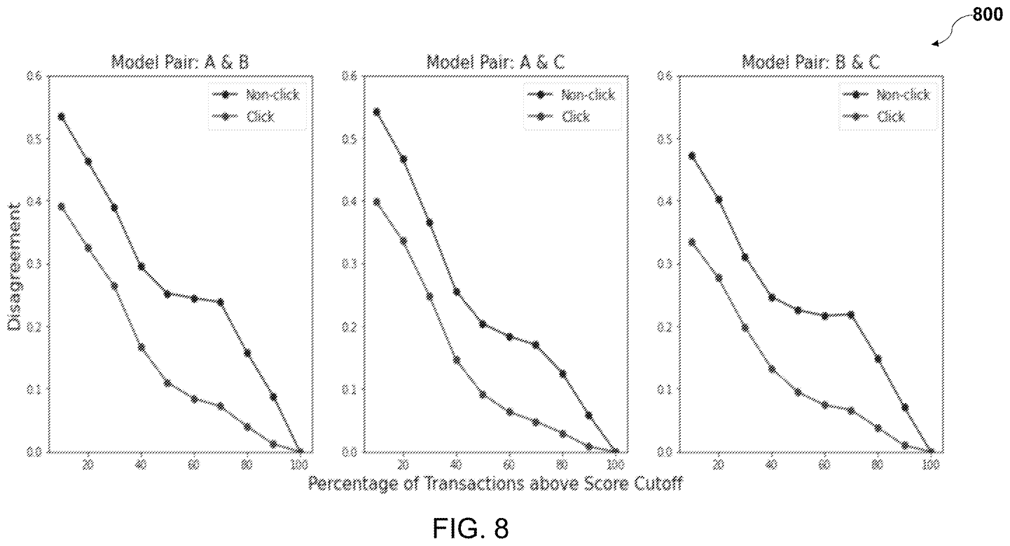

Referring now to FIG. 8, which is a graph 800 showing disagreements between example models, FIG. 8 shows disagreements on true positives (clicks) and false positives (non-clicks) among three models. There are two interesting findings from FIG. 8. A first finding is that disagreements on false positives (blue lines) are much more serious than disagreements on true positives (red lines). This finding raises the following question: in CTR prediction, or event prediction in general, all current efforts are focused on identifying events. Should efforts to identify non-events, that is, try to reduce false positives also be made? The second finding is that, Model C, trained using 70 features recommended by LFD, has less disagreements with Model B in both true positives and false positives at the high-score regions (refer to right panel), compared with Model A (refer to middle panel), even though Model A and Model B have similar architecture (both are logistic regression models).

Table 1 below shows the area under the curve (AUC) from the three models in FIG. 8.

TABLE 1

| | Training | | OOT | |
|---|---|---|---|---|
| Model/Performance | AUC | LogLoss | AUC | LogLoss |
| Model A | 0.7569 | 0.3936 | 0.7431 | 0.3991 |
| Model B | 0.7932 | 0.3710 | 0.7470 | 0.3989 |
| Model C | 0.7857 | 0.3767 | 0.7530 | 0.3953 |

Table 2 below presents the top 20 features recommended by LFD based on two types of disagreements from Model A and Model B, disagreements on true positives (refer to left panel), and disagreements on false positives (refer to middle panel). It is interesting to notice that these two sets of features are pretty much in agreement. Also included in the table are the top 20 features from the agreed instances (refer to the right panel). These are instances either correctly classified by both models (TPAB) or incorrectly classified by both models (FPAB). Intuitively, it is very hard to differentiate instances in TPAB from instances in FPAB. This is indeed the case: the IV values in the right panel all have a smaller value, indicating the signals used to separate these two populations are very weak.

TABLE 2

| | | |
|---|---|---|
| TP_{A} vs TP_{B} | FP_{A} vs FP_{B} | TP_{AB} vs FP_{AB} |

| | | | | | |
|---|---|---|---|---|---|
| [symbol] | [symbol] | [symbol] | [symbol] | [symbol] | [symbol] |
| [symbol] | [symbol] | [symbol] | [symbol] | [symbol] | [symbol] |
| [symbol] | [symbol] | [symbol] | [symbol] | [symbol] | [symbol] |
| [symbol] | [symbol] | [symbol] | [symbol] | [symbol] | [symbol] |
| [symbol] | [symbol] | [symbol] | [symbol] | [symbol] | [symbol] |
| [symbol] | [symbol] | [symbol] | [symbol] | [symbol] | [symbol] |
| [symbol] | [symbol] | [symbol] | [symbol] | [symbol] | [symbol] |
| [symbol] | [symbol] | [symbol] | [symbol] | [symbol] | [symbol] |
| [symbol] | [symbol] | [symbol] | [symbol] | [symbol] | [symbol] |
| [symbol] | [symbol] | [symbol] | [symbol] | [symbol] | [symbol] |
| [symbol] | [symbol] | [symbol] | [symbol] | [symbol] | [symbol] |
| [symbol] | [symbol] | [symbol] | [symbol] | [symbol] | [symbol] |
| [symbol] | [symbol] | [symbol] | [symbol] | [symbol] | [symbol] |
| [symbol] | [symbol] | [symbol] | [symbol] | [symbol] | [symbol] |
| [symbol] | [symbol] | [symbol] | [symbol] | [symbol] | [symbol] |
| [symbol] | [symbol] | [symbol] | [symbol] | [symbol] | [symbol] |
| [symbol] | [symbol] | [symbol] | [symbol] | [symbol] | [symbol] |
| [symbol] | [symbol] | [symbol] | [symbol] | [symbol] | [symbol] |
| [symbol] | [symbol] | [symbol] | [symbol] | [symbol] | [symbol] |
| [symbol] | [symbol] | [symbol] | [symbol] | [symbol] | [symbol] |
| [symbol] | [symbol] | [symbol] | [symbol] | [symbol] | [symbol] |

[symbol]

indicates data missing or illegible when filed

### Example Application Case 2: Anomaly Detection

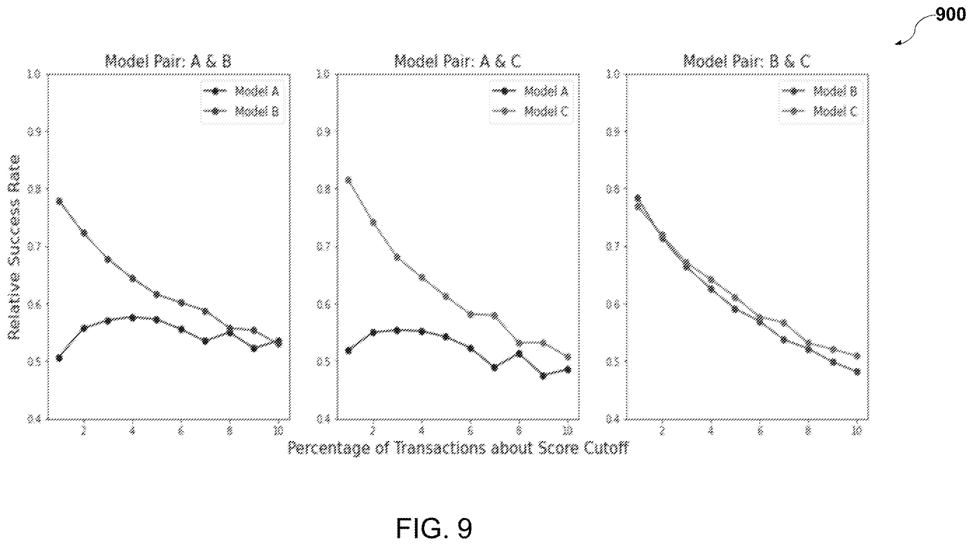

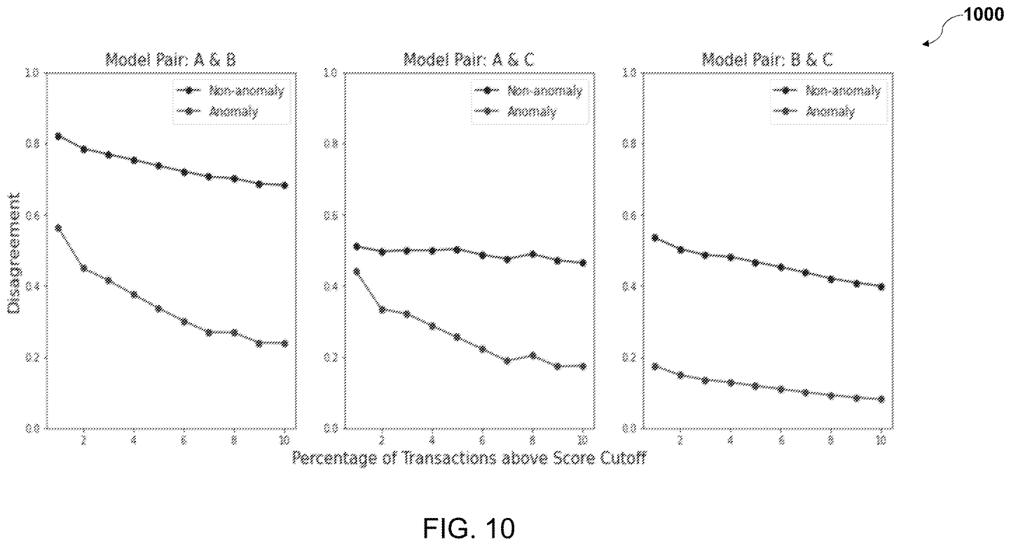

The pair of models used in this application is a gradient boosting tree model and a recurrent neural network (RNN) model, unlike in Example Application Case 1, where we show the predictive power from features recommend by LFD. What we want to demonstrate in this application case is that LFD helps us understand how ensemble works when we ensemble the gradient boosting tree model and the RNN model. FIG. 9, which is a graph 900 showing relative success rates between example models, shows the gradient boosting tree model, named Model A, the RNN model, named Model B, and the ensemble, named Model C. FIG. 10, which is a graph 1000 showing disagreements between example models, in particular, shows disagreements on true positives (anomalies) and false positives (non-anomalies) among the three models.

An interesting finding is from the middle panel and right panel: Ensemble reduces disagreement more on the gradient boosting tree model on false positives (refer to blue curve in the middle panel), and in the meantime reduces disagreement more on RNN on true positives (refer to red curve in the right panel). Notice in the above analysis, the ensemble weights are set as 0.5 for both models. This is on purpose because it enables seeing if the ensemble works if two model scores are treated equally (aligned using the algorithm introduced in Session 2).

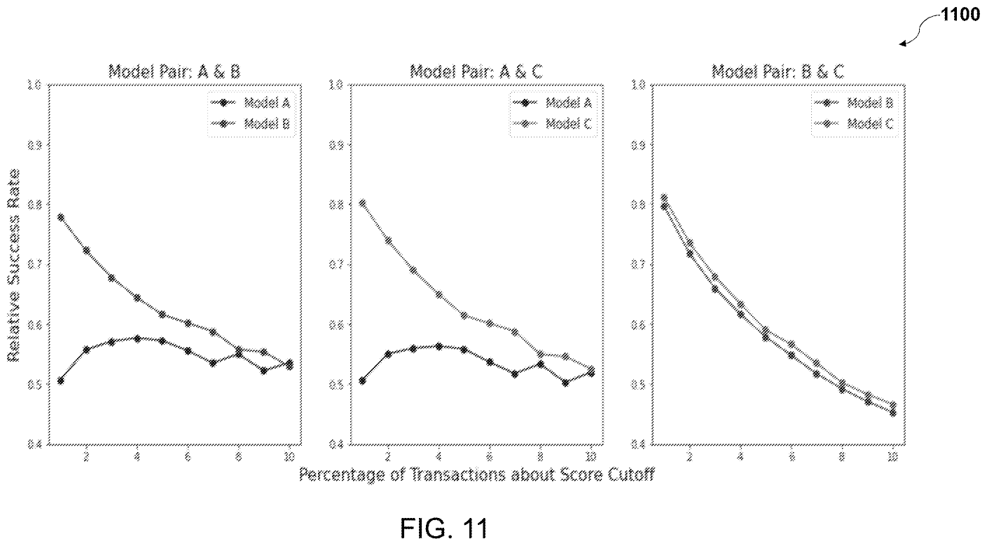

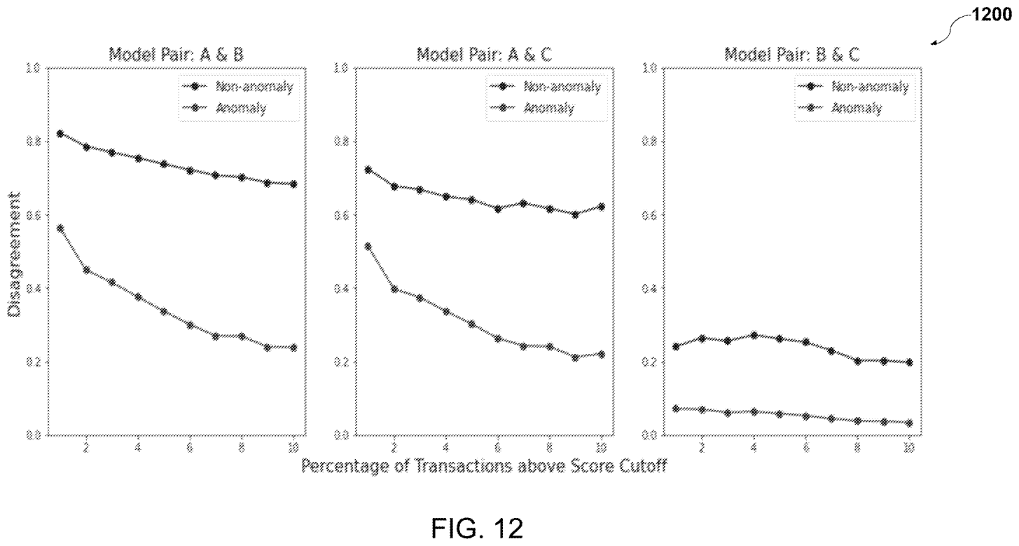

As a comparison, FIGS. 11 and 12 include graphs 1100 and 1200 showing the relative success rate curves and disagreement curves when we apply a weight 0.2 to the gradient boosting tree model and a weight 0.8 to the RNN model.

Although embodiments or aspects have been described in detail for the purpose of illustration and description, it is to be understood that such detail is solely for that purpose and that embodiments or aspects are not limited to the disclosed embodiments or aspects, but, on the contrary, are intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A computer-implemented method, comprising:
obtaining, with at least one processor, a plurality of features associated with a plurality of samples and a plurality of labels for the plurality of samples;
generating, with the at least one processor, a plurality of first predictions for the plurality of samples by providing, as input to a first machine learning model, a first subset of features of the plurality of features, and receiving, as output from the first machine learning model, the plurality of first predictions for the plurality of samples;
generating, with the at least one processor, a plurality of second predictions for the plurality of samples by providing, as input to a second machine learning model, a second subset of features of the plurality of features, and receiving, as output from the second machine learning model, the plurality of second predictions for the plurality of samples;
generating, with the at least one processor, based on the plurality of first predictions, the plurality of second predictions, the plurality of labels, and a plurality of groups of samples of the plurality of samples;
determining, with the at least one processor, based on the plurality of groups of samples, a first success rate associated with the first machine learning model and a second success rate associated with the second machine learning model; and
identifying, with the at least one processor, based on the first success rate and the second success rate, a weak point in the second machine learning model associated with a first portion of samples of the plurality of samples including a same first value for a same first feature of the plurality of features and for which the first success rate associated with the first machine learning model is different than the second success rate associated with the second machine learning model.

2. The computer-implemented method of claim 1, wherein at least one of: (i) the first subset of features is different than the second subset of features; (ii) a first set of hyperparameters for a machine learning algorithm used to generate the first machine learning model is different than a second set of hyperparameters for a same machine learning algorithm used to generate the second machine learning model; (iii) a first machine learning algorithm used to generate the first machine learning model is different than a second machine learning algorithm used to generate the second machine learning model; and (iv) a first training data set used to train the first machine learning model is different than a second training data set used to train the second machine learning model.

3. The computer-implemented method of claim 1, wherein the first subset of features is different than the second subset of features, and wherein identifying the weak point in the second machine learning model further includes:
determining a difference in features between the first subset of features and the second subset of features;
selecting, based on the same first feature included in the first portion of samples and the difference in features, one or more features of the plurality of features;
adjusting the second subset of features based on the selected one or more features; and
generating, using the adjusted second subset of features, an updated second machine learning model.

4. The computer-implemented method of claim 1, wherein a first set of hyperparameters for a machine learning algorithm used to generate the first machine learning model is different than a second set of hyperparameters for a same machine learning algorithm used to generate the second machine learning model, and wherein identifying the weak point in the second machine learning model further includes:
determining a difference in hyperparameters between the first set of hyperparameters and the second set of hyperparameters;
determining, based on the same first feature included in the first portion of samples and the difference in the hyperparameters, one or more hyperparameters;
adjusting the second set of hyperparameters based on the selected one or more hyperparameters; and
generating, using the adjusted second set of hyperparameters, an updated second machine learning model.

5. The computer-implemented method of claim 1, wherein the plurality of first predictions include a plurality of first prediction scores, wherein the plurality of second predictions include a plurality of second prediction scores, and wherein generating the plurality of groups of samples of the plurality of samples further includes:
aligning the plurality of second prediction scores to a same scale as the plurality of first prediction scores;
applying an operating point to the plurality of first prediction scores to determine a plurality of first positive predictions and a plurality of first negative predictions;
applying the operating point to the plurality of aligned second prediction scores to determine a plurality of second positive predictions and a plurality of second negative predictions; and
generating, based on the plurality of first positive predictions, the plurality of first negative predictions, the plurality of second positive predictions, the plurality of second negative predictions, the plurality of labels, and the plurality of groups of samples of the plurality of samples.

6. The computer-implemented method of claim 5, wherein aligning the plurality of second prediction scores to the same scale as the plurality of first prediction scores includes:
assigning each first prediction score of the plurality of prediction scores to a first bucket of a plurality of first buckets according to a value of that first prediction score;
determining, for each first bucket, a rate of positive first predictions up to the value of the first prediction score assigned to that first bucket;
assigning each second prediction score of the plurality of prediction scores to a second bucket of a plurality of second buckets according to a value of that second prediction score;
determining, for each second bucket, a rate of positive second predictions up to the value of the second prediction score assigned to that second bucket; and
determining, for each second prediction score, an aligned score aligned to the same scale as the plurality of first predictions scores, the value of the first prediction score assigned to the first bucket of the plurality of first buckets for which the rate of positive first predictions is a same rate as the rate of positive second predictions of the second bucket to which that prediction score is assigned.

7. The computer-implemented method of claim 1, wherein generating the plurality of groups of samples of the plurality of samples includes:
determining, with the at least one processor, a first group of samples of the plurality of samples for which a first prediction of the plurality of first predictions matches a label of the plurality of labels and a second prediction of the plurality of second predictions matches the label of the plurality of labels;
determining, with the at least one processor, a second group of samples of the plurality of samples for which the second prediction of the plurality of second predictions matches the label of the plurality of labels and the first prediction of the plurality of first predictions does not match the label of the plurality of labels;
determining, with the at least one processor, a third group of samples of the plurality of samples for which the first prediction of the plurality of first predictions matches the label of the plurality of labels and the second prediction of the plurality of second predictions does not match the label of the plurality of labels;
determining, with the at least one processor, a fourth group of samples of the plurality of samples for which the second prediction of the plurality of second predictions does not match the label of the plurality of labels and the first prediction of the plurality of first predictions does not match the label of the plurality of labels;
determining, with the at least one processor, a fifth group of samples of the plurality of samples for which the first prediction of the plurality of first predictions does not match the label of the plurality of labels and the second prediction of the plurality of second predictions matches the label of the plurality of labels; and
determining, with the at least one processor, a sixth group of samples of the plurality of samples for which the second prediction of the plurality of second predictions does not match the label of the plurality of labels and the first prediction of the plurality of first predictions matches the label of the plurality of labels.

8. The computer-implemented method of claim 7, wherein the first success rate associated with the first machine learning model and the second success rate associated with the second machine learning model are determined according to the following Equations (1) and (2):
$$First Success Rate = \frac{X 1 + Z 1 + λ ( Z 2 )}{X 1 + Y 1 + Z 1 + λ ( X 2 + Y 2 + Z 2 )} \qquad ( 1 )$$
$$Second Success Rate = \frac{X 1 + Y 1 + λ ( Y 2 )}{X 1 + Y 1 + Z 1 + λ ( X 2 + Y 2 + Z 2 )} \qquad ( 2 )$$
where X1 is a number of samples in the first group of samples, Y1 is a number of samples in the second group of samples, Z1 is a number of samples in the third group of samples, X2 is a number of samples in the fourth group of samples, Y2 is a number of samples in the fifth group of samples, Z2 is a number of samples in the sixth group of samples, and λ is a discount factor.

9. A system, comprising:
at least one processor programmed and/or configured to:
obtain a plurality of features associated with a plurality of samples and a plurality of labels for the plurality of samples;
generate a plurality of first predictions for the plurality of samples by providing, as input to a first machine learning model, a first subset of features of the plurality of features, and receiving, as output from the first machine learning model, the plurality of first predictions for the plurality of samples;
generate a plurality of second predictions for the plurality of samples by providing, as input to a second machine learning model, a second subset of features of the plurality of features, and receiving, as output from the second machine learning model, the plurality of second predictions for the plurality of samples;
generate, based on the plurality of first predictions, the plurality of second predictions, the plurality of labels, and a plurality of groups of samples of the plurality of samples;
determine, based on the plurality of groups of samples, a first success rate associated with the first machine learning model and a second success rate associated with the second machine learning model; and
identify, based on the first success rate and the second success rate, a weak point in the second machine learning model associated with a first portion of samples of the plurality of samples including a same first value for a same first feature of the plurality of features and for which the first success rate associated with the first machine learning model is different than the second success rate associated with the second machine learning model.

10. The system of claim 9, wherein at least one of: (i) the first subset of features is different than the second subset of features; (ii) a first set of hyperparameters for a machine learning algorithm used to generate the first machine learning model is different than a second set of hyperparameters for a same machine learning algorithm used to generate the second machine learning model; (iii) a first machine learning algorithm used to generate the first machine learning model is different than a second machine learning algorithm used to generate the second machine learning model; and (iv) a first training data set used to train the first machine learning model is different than a second training data set used to train the second machine learning model.

11. The system of claim 9, wherein the first subset of features is different than the second subset of features, and wherein the at least one processor is programmed and/or configured to identify the weak point in the second machine learning model by:
determining a difference in features between the first subset of features and the second subset of features;
selecting, based on the same first feature included in the first portion of samples and the difference in features, one or more features of the plurality of features;
adjusting the second subset of features based on the selected one or more features; and
generating, using the adjusted second subset of features, an updated second machine learning model.

12. The system of claim 9, wherein a first set of hyperparameters for a machine learning algorithm used to generate the first machine learning model is different than a second set of hyperparameters for a same machine learning algorithm used to generate the second machine learning model, and wherein the at least one processor is programmed and/or configured to identify the weak point in the second machine learning model further by:
determining a difference in hyperparameters between the first set of hyperparameters and the second set of hyperparameters;
determining, based on the same first feature included in the first portion of samples and the difference in the hyperparameters, one or more hyperparameters;
adjusting the second set of hyperparameters based on the selected one or more hyperparameters; and
generating, using the adjusted second set of hyperparameters, an updated second machine learning model.

13. The system of claim 9, wherein the plurality of first predictions include a plurality of first prediction scores, wherein the plurality of second predictions include a plurality of second prediction scores, and wherein the at least one processor is programmed and/or configured to generate the plurality of groups of samples of the plurality of samples further by:
aligning the plurality of second prediction scores to a same scale as the plurality of first prediction scores;
applying an operating point to the plurality of first prediction scores to determine a plurality of first positive predictions and a plurality of first negative predictions;
applying the operating point to the plurality of aligned second prediction scores to determine a plurality of second positive predictions and a plurality of second negative predictions; and
generating, based on the plurality of first positive predictions, the plurality of first negative predictions, the plurality of second positive predictions, the plurality of second negative predictions, the plurality of labels, and the plurality of groups of samples of the plurality of samples.

14. The system of claim 13, wherein the at least one processor is programmed and/or configured to align the plurality of second prediction scores to the same scale as the plurality of first prediction scores by:
assigning each first prediction score of the plurality of prediction scores to a first bucket of a plurality of first buckets according to a value of that first prediction score;
determining, for each first bucket, a rate of positive first predictions up to the value of the first prediction score assigned to that first bucket;
assigning each second prediction score of the plurality of prediction scores to a second bucket of a plurality of second buckets according to a value of that second prediction score;
determining, for each second bucket, a rate of positive second predictions up to the value of the second prediction score assigned to that second bucket; and
determining, for each second prediction score, an aligned score aligned to the same scale as the plurality of first predictions scores, the value of the first prediction score assigned to the first bucket of the plurality of first buckets for which the rate of positive first predictions is a same rate as the rate of positive second predictions of the second bucket to which that prediction score is assigned.

15. The system of claim 9, wherein the at least one processor is programmed and/or configured to generate the plurality of groups of samples of the plurality of samples by:
determining, with the at least one processor, a first group of samples of the plurality of samples for which a first prediction of the plurality of first predictions matches a label of the plurality of labels and a second prediction of the plurality of second predictions matches the label of the plurality of labels;
determining, with the at least one processor, a second group of samples of the plurality of samples for which the second prediction of the plurality of second predictions matches the label of the plurality of labels and the first prediction of the plurality of first predictions does not match the label of the plurality of labels;
determining, with the at least one processor, a third group of samples of the plurality of samples for which the first prediction of the plurality of first predictions matches the label of the plurality of labels and the second prediction of the plurality of second predictions does not match the label of the plurality of labels;
determining, with the at least one processor, a fourth group of samples of the plurality of samples for which the second prediction of the plurality of second predictions does not match the label of the plurality of labels and the first prediction of the plurality of first predictions does not match the label of the plurality of labels;
determining, with the at least one processor, a fifth group of samples of the plurality of samples for which the first prediction of the plurality of first predictions does not match the label of the plurality of labels and the second prediction of the plurality of second predictions matches the label of the plurality of labels; and
determining, with the at least one processor, a sixth group of samples of the plurality of samples for which the second prediction of the plurality of second predictions does not match the label of the plurality of labels and the first prediction of the plurality of first predictions matches the label of the plurality of labels.

16. The system of claim 15, wherein the first success rate associated with the first machine learning model and the second success rate associated with the second machine learning model are determined according to the following Equations (1) and (2):
$$First Success Rate = \frac{X 1 + Z 1 + λ ( Z 2 )}{X 1 + Y 1 + Z 1 + λ ( X 2 + Y 2 + Z 2 )} \qquad ( 1 )$$
$$Second Success Rate = \frac{X 1 + Y 1 + λ ( Y 2 )}{X 1 + Y 1 + Z 1 + λ ( X 2 + Y 2 + Z 2 )} \qquad ( 2 )$$
where X1 is a number of samples in the first group of samples, Y1 is a number of samples in the second group of samples, Z1 is a number of samples in the third group of samples, X2 is a number of samples in the fourth group of samples, Y2 is a number of samples in the fifth group of samples, Z2 is a number of samples in the sixth group of samples, and λ is a discount factor.

17. A computer program product comprising at least one non-transitory computer-readable medium including program instructions that, when executed by at least one processor, cause the at least one processor to:
obtain a plurality of features associated with a plurality of samples and a plurality of labels for the plurality of samples;
generate a plurality of first predictions for the plurality of samples by providing, as input to a first machine learning model, a first subset of features of the plurality of features, and receiving, as output from the first machine learning model, the plurality of first predictions for the plurality of samples;
generate a plurality of second predictions for the plurality of samples by providing, as input to a second machine learning model, a second subset of features of the plurality of features, and receiving, as output from the second machine learning model, the plurality of second predictions for the plurality of samples;
generate, based on the plurality of first predictions, the plurality of second predictions, the plurality of labels, and a plurality of groups of samples of the plurality of samples;
determine, based on the plurality of groups of samples, a first success rate associated with the first machine learning model and a second success rate associated with the second machine learning model; and
identify, based on the first success rate and the second success rate, a weak point in the second machine learning model associated with a first portion of samples of the plurality of samples including a same first value for a same first feature of the plurality of features and for which the first success rate associated with the first machine learning model is different than the second success rate associated with the second machine learning model.

18. The computer program product of claim 17, wherein at least one of: (i) the first subset of features is different than the second subset of features; (ii) a first set of hyperparameters for a machine learning algorithm used to generate the first machine learning model is different than a second set of hyperparameters for a same machine learning algorithm used to generate the second machine learning model; (iii) a first machine learning algorithm used to generate the first machine learning model is different than a second machine learning algorithm used to generate the second machine learning model; and (iv) a first training data set used to train the first machine learning model is different than a second training data set used to train the second machine learning model.

19. The computer program product of claim 17, wherein the instructions cause the at least one processor to generate the plurality of groups of samples of the plurality of samples by:
determining, with the at least one processor, a first group of samples of the plurality of samples for which a first prediction of the plurality of first predictions matches a label of the plurality of labels and a second prediction of the plurality of second predictions matches the label of the plurality of labels;
determining, with the at least one processor, a second group of samples of the plurality of samples for which the second prediction of the plurality of second predictions matches the label of the plurality of labels and the first prediction of the plurality of first predictions does not match the label of the plurality of labels;
determining, with the at least one processor, a third group of samples of the plurality of samples for which the first prediction of the plurality of first predictions matches the label of the plurality of labels and the second prediction of the plurality of second predictions does not match the label of the plurality of labels;
determining, with the at least one processor, a fourth group of samples of the plurality of samples for which the second prediction of the plurality of second predictions does not match the label of the plurality of labels and the first prediction of the plurality of first predictions does not match the label of the plurality of labels;
determining, with the at least one processor, a fifth group of samples of the plurality of samples for which the first prediction of the plurality of first predictions does not match the label of the plurality of labels and the second prediction of the plurality of second predictions matches the label of the plurality of labels; and
determining, with the at least one processor, a sixth group of samples of the plurality of samples for which the second prediction of the plurality of second predictions does not match the label of the plurality of labels and the first prediction of the plurality of first predictions matches the label of the plurality of labels.

20. The computer program product of claim 19, wherein the first success rate associated with the first machine learning model and the second success rate associated with the second machine learning model are determined according to the following Equations (1) and (2):
$$First Success Rate = \frac{X 1 + Z 1 + λ ( Z 2 )}{X 1 + Y 1 + Z 1 + λ ( X 2 + Y 2 + Z 2 )} \qquad ( 1 )$$
$$Second Success Rate = \frac{X 1 + Y 1 + λ ( Y 2 )}{X 1 + Y 1 + Z 1 + λ ( X 2 + Y 2 + Z 2 )} \qquad ( 2 )$$
where X1 is a number of samples in the first group of samples, Y1 is a number of samples in the second group of samples, Z1 is a number of samples in the third group of samples, X2 is a number of samples in the fourth group of samples, Y2 is a number of samples in the fifth group of samples, Z2 is a number of samples in the sixth group of samples, and λ is a discount factor.
